(19) United States
(12) Patent Application Publication
(10) Pub. No.: US 2008/0238762 A1
(43) Pub. Date: Oct. 2, 2008

(54) SYSTEM AND METHODS FOR MULTISTEP TARGET DETECTION AND PARAMETER ESTIMATION

(76) Inventor: Donald Spyro Gumas, Middletown, MD (US)

Correspondence Address: JONES DAY, 222 EAST 41ST ST, NEW YORK, NY, 10017, US

(21) Appl. No.: 12/023,137

(22) Filed: Jan. 31, 2008

Related U.S. Application Data
(60) Provisional application No. 60/898,879, filed on Jan. 31, 2007.

(51) Int. Cl. G01S 13/00

(52) U.S. Cl. 342/99

(57) ABSTRACT

A system and methods for multistep target detection and parameter estimation which utilizes slices and/or projections of the cross-ambiguity function of the transmitted and received signals of a sensor system is disclosed. The system and methods of the present invention offer a computationally efficient means of detecting targets while achieving a high probability of detection and a reduced false alarm rate. Detection and parameter estimation of targets is accomplished by generating hypotheses and then validating the generated hypotheses. The hypotheses are generated using slices and/or projections of cross-ambiguity functions of transmitted signals and reflections received from the targets without the need to compute the entire cross-ambiguity function. After hypotheses are generated they are validated by determining the amplitude of a cross-ambiguity function at the coordinates of the hypotheses and comparing the amplitude to a predetermined threshold.

### CLAIM OF PRIORITY

This application claims priority of provisional applications Ser. No. 60/898,879 filed on Jan. 31, 2007, which is incorporated herein by reference.

### FIELD OF INVENTION

The present invention relates to active sensor applications, and more particularly is directed to efficient systems and methods for detection and tracking of one or more targets while minimizing the rate of false positive detections.

### BACKGROUND OF INVENTION

Detection and tracking of targets by sensor systems have been the subject matter of a large number of practical applications. Sensor systems designed for this purpose use propagating wave signals, such as electromagnetic or acoustical signals. Some sensor systems, such as radar and sonar systems, are designed to receive reflections of a transmitted signal generated by an appropriate transmitter, and determine the presence of objects (or targets) by analyzing the transmitted and the reflected signals. Active sensor systems detect targets by both transmitting signals, receiving their reflections, and analyzing both the transmitted and the received signals. In this disclosure the terms “object” and “target” are used interchangeably.

Active sensor systems are generally used for detection of scattering objects. In the presence of a scattering object, the transmitted signal is reflected from the object and the reflected signal arrives to the receiving sensor system with a certain time delay, which is related to the range of the scattering object (i.e., the distance from the target to the sensor system). Also, if the scattering object is moving, the reflected signal exhibits a spectral shift that is known as a Doppler shift. The Doppler shift depends on the relative radial velocity of the object with respect to the sensor system. In order to provide an example of a received signal in an active sensor system, a simulation has been conducted for a radar system that transmits a phase-coded radar signal as shown in FIG. 1A. In this simulation, the transmitted signal reflects back from an object, at a 12 km range, moving with a velocity of 400 m/s towards the radar system. The reflected signal is received by the radar antenna and down-converted by a conventional analog receiver system. The output of the analog receiver system is shown in FIG. 1B, where the effects of the object range and velocity are seen as a delay and an additional frequency modulation of the received signal, respectively. These two prominent effects of the received signal can be more readily observed on the cross-ambiguity function (CAF) of the transmitted and received signals, which is defined as:

Aᵣₛ(τ,ν)=∫r(t+τ/2)s*(t−τ/2)exp [j2πνt]dt,

where s(t) is the transmitted signal and r(t) is the received signal. For the transmitted and received signal pair shown in FIGS. 1A and 1B, respectively, the magnitude of the cross-ambiguity function is illustrated in FIG. 1C as a 3-dimensional plot. FIG. 1D shows the contour plot of the same cross-ambiguity function. As seen in FIG. 1D, the peak of the cross-ambiguity function is located at the corresponding delay and Doppler shift caused by the scattering object. This observed correspondence between the peak location of the cross-ambiguity function on one hand, and the position and the velocity of the scattering object on the other hand, is a general relationship, which holds true in most cases where there is no or little noise at the receiver. A person of ordinary skill in the art would recognize that the relative radial velocity of an object has a direct relationship to the Doppler shift in the cross-ambiguity domain and that the distance to the object has a direct relationship to the delay in the cross-ambiguity domain.

In the case of a noisy reception of the reflected signal, the peak location of the cross-ambiguity function still provides a reliable estimate of the delay and the Doppler shift caused by the scattering object. Therefore, in accordance with the present invention it is possible to detect the presence of one or more scattering objects by finding the peak locations of the cross-ambiguity function and comparing them with appropriately chosen threshold levels. The peaks that exceed the thresholds can be identified as scattering objects, and the locations of the peaks will provide the corresponding delay and Doppler shift information at the same time. Such peaks of the cross ambiguity function may be computed by calculating the entire cross-ambiguity function and then examining it for peaks, as generally known in the art. This computation is complex and processor intensive.

Methods of identifying peaks without having to compute the entire cross-ambiguity function are also known in the art. One such method is known in the art and is disclosed in U.S. Pat. No. 6,636,174, incorporated herein by reference. To detect a target in accordance with the U.S. Pat. No. 6,636,174, two projections at different angles of the cross-ambiguity function are computed. A projection is a collection of integrals (or summation of samples) taken over uniformly spaced paths perpendicular to the axis of the projection (also called a projection line) in the cross-ambiguity function Doppler shift/time delay plane at a selected angle. The angle of the projections would be pre-determined by the selection of a signal and by the clutter and interference environment.

The U.S. Pat. No. 6,636,174 also discloses another method for detecting a target. In accordance with this method, a projection is computed first and then if a peak, signifying the presence of at least one target, on this projection is detected, a slice passing through the peak of the projection is computed to localize the peak of the cross-ambiguity function, where a slice is a plurality of samples of the cross-ambiguity function lying over a line or line segment. The angle of the projections would be pre-determined by the selection of a signal and by the clutter and interference environment or, alternatively, a plurality of projections at different angles may be computed and the one with the highest peaks is chosen as the basis for further computations. All projections may be computed without sending and receiving additional signals. Once the peak on the desired projection is found, the slice, oriented parallel to the path of integration of the projection, is computed. One or more peaks on the slice signify targets in the cross-ambiguity function Doppler-shift/time delay plane.

Another method for efficient detection of targets by identification of peaks in a cross-ambiguity function is disclosed in U.S. Pat. No. 7,317,417, which is incorporated herein by reference. The method involves transmitting a signal that is known to produce a ridge of a pre-defined angle in the Doppler shift/dime delay plane, such as a linear frequency modulated (LFM) signal. After the signal is transmitted, a slice at an angle known to cross the ridge in the cross-ambiguity function is computed. Note that multiple targets may or may not result in the multiple ridges of the cross-ambiguity function. If respective velocities and distances of two or more targets result in the Doppler shift and time delay that are on the same line of the ridge, only a single ridge results.

Once one or more ridges, signifying the presence of one or more targets are detected, a second signal, which is known to produce a highly localized, thumb tack cross-ambiguity function, such as a pseudo-random noise (PN) signal is transmitted. One or more second slices are computed at an angle of the first ridge(s) in cross-ambiguity function and traversing the coordinates in the cross-ambiguity function Doppler-shift/time delay plane where the first slice has peaks due to ridges in the cross-ambiguity function of the first signal and its reflection from one or more targets. The positions of the peaks on the second slice of the cross-ambiguity function signify the Doppler shift and time delay of the actual targets.

Although this method is efficient in terms of processing, it is prone to false target detection. In particular, side lobes of the second signal may lie along the same ridge line of the cross-ambiguity function of the first signal and its reflection. If the side lobes are of sufficient amplitude and exceed a detection threshold, they might be identified as targets. This typically occurs with targets that result in a relatively strong reflection signal.

Accordingly, there is presently a need for an efficient and low-cost system and method that can reliably detect scattering objects and estimate both their time delay (i.e. distance to the radar) and their Doppler shifts (i.e. relative radial velocity) at the same time, without actually computing the entire cross-ambiguity function while minimizing the rate of false detections.

### SUMMARY OF THE INVENTION

The present invention provides a remedy for the above-discussed disadvantage/problem. The above objective are accomplished by a method of detecting one or more targets. The method includes generating one or more target hypotheses in a Doppler-shift/time delay plane based on one or more curves of one or more cross ambiguity functions of one or more transmitted signals and their received reflections from the one or more targets, and determining one or more coordinates of the one or more targets in the Doppler-shift/time delay plane by validating the one or more generated target hypotheses. The Doppler-shift/time delay plane is a cross-ambiguity function Doppler-shift/time plane.

A further embodiment includes a system for detecting one or more targets. The system includes a waveform generator for producing samples of waveforms to be transmitted, a signal transmitter for optionally converting the samples of waveforms to an analog signal, amplifying and transmitting the converted signal, and a signal receiver for receiving, amplifying and optionally converting received signals to a digital format. The system further includes a detection processor for determining the existence of targets. The detection processor includes a curve processor for extrapolating curves of the cross-ambiguity function of transmitted and received signals, a target hypothesis generator for generating Doppler-shift/time delay coordinates of hypothetical targets, and a hypothesis validation processor for analyzing each hypothetical target and determining whether each hypothetical target is an actual target.

A still further embodiment relates to a system for detecting one or more targets. The system includes means for generating one or more target hypotheses in a Doppler-shift/time delay plane based on one or more curves of one or more cross ambiguity functions of one or more transmitted signals and their received reflections from the one or more targets, and means for determining one or more coordinates of the one or more targets in the Doppler-shift/time delay plane by validating the one or more generated target hypotheses. The Doppler-shift/time delay plane is a cross-ambiguity function Doppler-shift/time plane.

In still a further embodiment a computer program, where a product comprising a medium with instructions stored thereon, causes a computer system to generate one or more target hypotheses in a Doppler-shift/time delay plane based on one or more curves of one or more cross ambiguity functions of one or more transmitted signals and their received reflections from the one or more targets. The computer program further causes a computer system to determine one or more coordinates of the one or more targets in the Doppler-shift/time delay plane by validating the one or more generated target hypotheses. The Doppler-shift/time delay plane is a cross-ambiguity function Doppler-shift/time plane.

Other objectives and advantages in addition to those discussed above will become apparent to those skilled in the art during the course of the description of a preferred embodiment of the invention which follows. In the description, reference is made to accompanying drawings, which form a part thereof, and which illustrate an example of the invention. Such example, however, is not exhaustive of the various embodiments of the invention, and the claims that follow should not be limited to the examples shown.

### BRIEF DESCRIPTION OF THE DRAWINGS

The present invention may be understood more fully by reference to the following detailed description of one of the exemplary embodiments of the present invention, illustrative examples of specific embodiments of the invention, and the appended figures in which:

FIG. 1 is an illustration for an active sensor application where in FIG. 1A the transmitted signal is shown; in FIG. 1B the received signal is shown; in FIG. 1C the 3-dimensional plot of the cross-ambiguity function of the received and transmitted signals is shown; in FIG. 1D contour plot of the cross-ambiguity function of the received and transmitted signals is shown.

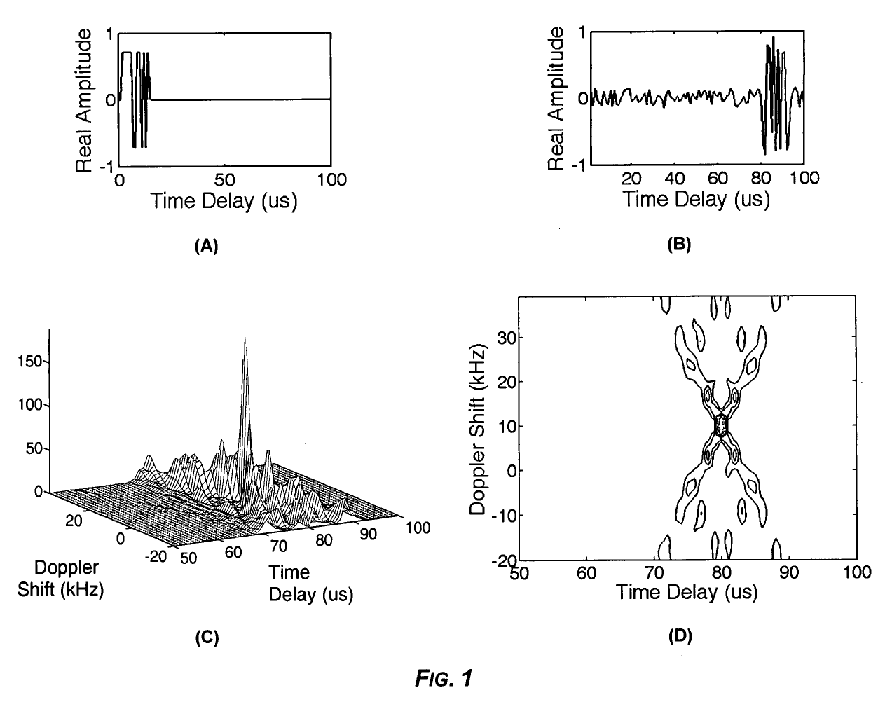

FIG. 2 is a flow chart of an embodiment of the target detection method.

FIG. 3 is a block diagram of an embodiment of a sensor system for performing the target detection method.

FIG. 4 is a block diagram of a detection processor of the sensor system depicted in FIG. 3.

FIGS. 5A-5C are illustrations of an LFM signal where in FIG. 5A shows the LFM signal with an increasing frequency chirp, FIG. 5B shows the 3D profile of the LFM signal's auto-ambiguity function, and FIG. 5C shows the LFM signal's curve in the auto-ambiguity function Doppler-shift/time delay plane.

FIGS. 6A-6C are illustrations of an LFM signal where in FIG. 6A shows the LFM signal with a decreasing frequency chirp, FIG. 6B shows the 3D profile of the LFM signal's auto-ambiguity function, and FIG. 6C shows the LFM signal's curve in the auto-ambiguity function Doppler-shift/time delay plane.

FIGS. 7A-7C are illustrations of a two LFM composite signal where in FIG. 7A shows the two LFM composite signal with both an increasing and decreasing frequency chirp, FIG. 7B shows the 3D profile of the two LFM composite signal's auto-ambiguity function, and FIG. 7C shows the two LFM composite signal's curve in the auto-ambiguity function Doppler-shift/time delay plane.

FIG. 8 is a flow chart of an embodiment of step 2 of FIG. 2.

FIG. 9A is an illustration of two targets in the velocity/range domain.

FIG. 9B is an illustration of the two targets of FIG. 9A in the Doppler-shift/time delay plane.

FIG. 10 is an illustration of a 3D profile of a first (preliminary detection) cross-ambiguity function resulting from the two targets of FIG. 9A.

FIG. 11 is an illustration of a 2D contour plot of the first (preliminary detection) cross-ambiguity function of FIG. 10.

FIG. 12 is an illustration of a slice amplitude profile of the first (preliminary detection) cross-ambiguity function corresponding to the ridges depicted in FIGS. 10 and 11 computed along line 90.

FIG. 13 is an illustration of a projection amplitude profile of the first (preliminary detection) cross-ambiguity function corresponding to the ridges depicted in FIGS. 10 and 11 projected along the path of integration, line 92.

FIGS. 14A-C are illustrations of various curve locations in the cross-ambiguity function Doppler-shift/time delay plane where the slice peaks have the same location.

FIG. 15 is an illustration of the computed functions of the lines over which the curves of the first cross-ambiguity function lie in the Doppler-shift/time delay plane.

FIG. 16 is an illustration a 3D profile of the intermediate detection cross-ambiguity function resulting from the targets of FIG. 9A.

FIG. 17 is an illustration of a 2D contour plot of the intermediate detection cross-ambiguity function resulting from the targets of FIG. 9A.

FIG. 18 is an illustration of a slice amplitude profile of the intermediate detection cross-ambiguity function corresponding to the ridges depicted in FIGS. 16 and 17 computed along line 100.

FIG. 19 is an illustration of a projection amplitude profile of the intermediate detection cross-ambiguity function corresponding to the ridges depicted in FIGS. 16 and 17 projected along the path of integration, line 102.

FIGS. 20A-C are illustrations of various curve locations in the cross-ambiguity function Doppler-shift/time delay plane where the slice peaks have the same location.

FIG. 21 is an illustration of the computed functions of the lines over which the curves of the second cross-ambiguity function lie in the Doppler-shift/time delay plane.

FIG. 22 is an illustration of the locations of target hypotheses.

FIG. 23 is a flow chart of another embodiment of step 2 of FIG. 2.

FIG. 24 is an illustration of a 3D profile of the first cross-ambiguity function resulting from the targets of FIG. 9A using a composite of two LFM signals.

FIG. 25 is an illustration of a contour plot of the first cross-ambiguity function resulting from the targets of FIG. 9A using a composite of two LFM signals.

FIG. 26 is an illustration of a slice amplitude profile corresponding to the ridges depicted in FIGS. 24 and 25 computed along line 190.

FIG. 27 is an illustration of the computed functions of lines over which some of the curves of the first cross-ambiguity function depicted in FIGS. 24 and 25 lie in the Doppler-shift/time delay plane.

FIG. 28 is an illustration of a slice amplitude profile corresponding to the ridges depicted in FIGS. 24 and 25 computed along line 192.

FIG. 29 is an illustration of computed functions of lines over which some of the curves of the first cross-ambiguity function depicted in FIGS. 24 and 25 lie in the Doppler-shift/time delay plane.

FIG. 30 is an illustration of the locations of target hypotheses.

FIG. 31 is a flow chart of the steps performed in step 4 of FIG. 2.

FIGS. 32A-C are illustrations of a signal having a thumb tack auto-ambiguity function where in FIG. 32A is an example of a pseudo-random noise signal, FIG. 32B is a 3D profile of the auto-ambiguity function of the pseudo-random noise signal, and FIG. 32C is a 2D contour plot of the auto-ambiguity function of the pseudo-random noise signal.

FIG. 33 is an illustration of a 3D profile plot of a final detection cross-ambiguity function.

FIG. 34 is an illustration of a 2D contour plot of the final detection cross-ambiguity function of FIG. 33.

### DETAILED DESCRIPTION OF THE EMBODIMENTS

A cross-ambiguity function reveals the presence of an object in sensor applications. However, due to the associated complexity in the implementation of the required processing, detection in the cross-ambiguity function domain is rarely used in practice. In this disclosure, an alternative method of detection of object in the cross-ambiguity function domain is proposed. For the purposes of this disclosure the term “object” is used interchangeably with the term “target.” In the preferred embodiment, slices and projections of the ambiguity function are used to generate target hypotheses. Once the hypotheses of the targets are identified, each one of them is validated to verify whether it corresponds to an actual target. A target hypothesis is a point on the cross-ambiguity function Doppler-shift/time delay plane that either corresponds to a target or does not correspond to a target. The generated target hypotheses include targets in the domain observed by the sensor system as well as some other points in the Doppler-shift/time delay plane, which do not correspond to targets. The hypotheses that do not correspond to targets are independent of and uncorrelated to the false target detections that may occur as a result of the high side lobes associated with thumb tack ambiguity function signals. Conversely, the hypotheses that do correspond to targets correlate well with the true target detections that occur as a result of the highly localized peak associated with the thumb tack ambiguity function signals. Therefore the hypotheses serve to rule out most false target detections that would typically occur with the thumb tack ambiguity function signals, and the highly localized peak of the thumb tack ambiguity function serves to validate the typically few true targets from the typically many target hypotheses.

By way of review and introduction of relevant terminology, a cross-ambiguity function of the transmitted and received signals is defined as:

Aᵣₛ(τ,ν)=∫r(t+τ/2)s*(t−τ/2)exp [j2πνt]dt (1)

where s(t) is the transmitted signal and r(t) is the received signal.

A slice of an ambiguity function is a collection of samples of the ambiguity function lying over a line or a line segment in the Doppler shift/time delay plane. Slices of a cross-ambiguity function can be computed efficiently and accurately by using fractional-Fourier transformation, without computing the entire cross-ambiguity function. The fractional Fourier transformation of signal x(t) is defined as:

x_{2φ/π}(t)=∫K_{2φ/π}(t,t′)x(t′)dt′, (2)

where φ is the transformation angle, and K_{2φ/π} is the transformation kernel defined as:

K_{2φ/π}(t,t′)=k_{φ} exp [jπ(t² cot φ−2tt′ csc φ+t′² cot φ)] (3)

and the complex scaling k_{φ} defined as:

$${k}_{φ} = \frac{exp \{ j ( φ / 2 - π / 4 sgn φ ) \}}{\sqrt{\vert sin φ \vert}} . \qquad ( 4 )$$

The fractional Fourier transformation is a generalization of the ordinary Fourier transformation and reduces to ordinary Fourier transformation for φ=π/2. The fast fractional Fourier transformation algorithm enables efficient computation of the fractional Fourier transformation of a given signal. By using the fast fractional Fourier transformation techniques, the slices of the cross-ambiguity function can be computed efficiently. The governing equation is:

Aᵣₛ(τ₀+λ sinφ, ν₀+λ cos φ)=∫\hat{r}_{2φ/π}(μ)ŝ*_{2φ/π}(μ)exp [j2πλμ]dμ (5)

where τ₀ and ν₀ are the starting point of the slice, λ is the distance of the computed slice sample from the starting point (τ₀,ν₀) and φ is the angle of the slice and the integrands are the fractional Fourier transforms of the following shifted and modulated received and transmitted radar signals:

\hat{r}(t)=r(t+τ₀/2)exp [jπν₀t]

ŝ(t)=s(t−τ₀/2)exp [jπν₀t] (6)

If a relatively small number of samples of a slice should be computed, they can be computed with an alternative method, called a Doppler compensated matched filter, that is computationally less complex than the fractional Fourier transform method. With this alternative method, for the computation of Nₛ samples of the slice given in Equation (5), Aᵣₛ(τ₀+λₖ sin φ,νₖ cos φ), k=1, 2, . . . , Nₛ, the following equation can be used:

$$\begin{matrix}{A}_{rs} ( {τ}_{0} + {λ}_{k} sin φ , {v}_{0} + {λ}_{k} cos φ ) = \int r ( t + ( {τ}_{0} + {λ}_{k} sin φ ) / 2 {s}^{*} \\ ( t - ( {τ}_{0} + {λ}_{k} sin φ ) / 2 ) \times exp \\ [ - j2π ( {v}_{0} + {λ}_{k} cos φ ) t ] d t .\end{matrix} \qquad ( 7 )$$

where τ₀ and ν₀ are the starting point of the slice, λₖ the distance from the start point (τ₀,ν₀) to the k^{th} slice data sample (k goes from 1 to Nₛ where Nₛ is the number of samples computed on the slice) and φ is the angle of the slice.

The above Equation (7) provides the desired Aᵣₛ(τ₀+λₖ sin φ,ν₀+λₖ cos φ) sample of a Doppler compensated matched filter by computing the output at time τ₀+λₖ sin φ for a Doppler shift of ν₀+λₖ cos φ. For computational efficiency, the required output of the Doppler compensated matched filter in Equation (7) can be approximated by replacing the integral with a summation over the samples of the transmitted and reflected signals. Hence, with this alternative computation approach, if Nᵣ samples of the transmitted and received signals are used, each sample of the slice is computed by performing approximately Nᵣ multiplications and additions. If the number of samples Nₛ is small, more precisely it is less than 2 log₂(Nᵣ), samples are computed more efficiently with the alternative method, than with the method utilizing fractional Fourier transformation given in Equations (2) to (6).

Therefore, in the preferred embodiment of the invention, the alternative method of slice samples computation described in Equation (6) is used for the cases where the number of slice samples to be computed is small. Otherwise, if the number of samples to be computed is large, the fractional Fourier transform-based slice computation method described in Equations (2) to (6) is used.

In some embodiments, projections may be used to generate hypotheses of the targets. A projection is a collection of integrals (or summation of samples) taken over uniformly spaced paths perpendicular to the projection line in the Doppler shift/time delay plane at a selected angle. To compute a projection of an ambiguity function without computing the ambiguity function itself, the received signal is segmented into frames for further processing. For an analog receiver these frames can be constructed as:

r̅ᵢ=I(t+Δtᵢ+Tᵢ/2)+jQ(t+Δtᵢ+Tᵢ/2), −Tᵢ/2≦t<Tᵢ/2 (8)

By choosing the frame positions Δtᵢ's and the frame durations Tᵢ's properly, the frames can be constructed as overlapping or non-overlapping, as desired. For improved computational efficiency, in the implementation of the preferred embodiments, the following time-scaled signals are used:

rᵢ(t)= r̅ᵢ(t/s_{c}) (9)

For a signal with approximate time duration T and bandwidth B, the preferred scaling constant is given by:

s_{c}=\sqrt{B/T} (10)

For simplicity in the actual implementation, all of the constructed signal frames can be scaled with the same scaling constant. In this case, T should be chosen as the approximate time duration of the signal frame with the longest duration. Different scaling can be used in alternative embodiments.

Similarly, in accordance with the present invention, for a digital receiver the time-scaled signal frames are constructed from the available samples of the received signal as:

$$\begin{matrix}{r}_{l} [ n ] = {r}_{l} ( n / ( 2 Δ r ) ) \\ = {{r}^{}}_{l} ( {nT}_{S} ) \\ = I ( {nT}_{S} + {N}_{O} {T}_{S} ) + j Q ( {nT}_{S} + {N}_{O} {T}_{S} ) , \\ - {T}_{l} / 2 \leq {nT}_{S} < {T}_{l} / 2 ,\end{matrix} \qquad ( 11 )$$

where Δr is the square root of the time-bandwidth product TB of the signal r̅ᵢ(t), Tₛ=1/(2B) denotes the sampling interval used by the digital receiver, and N₀ is the closest integer to (Δtᵢ+Tᵢ/2)Tₛ.

In embodiments that use projections for identifying hypotheses, following the formation of the signal frames, for each of the constructed signal frames, the corresponding fractional Fourier transform is obtained. As mentioned above, the fractional Fourier transformation is a generalization of the ordinary Fourier transformation that can be interpreted as a rotation by an angle in the time-frequency plane. If the receiver provides analog signals, the following continuous fractional Fourier transformation is applied to the constructed signal frame:

$$\text{(} {r}_{i , {a}_{{i}_{j}}} ( t ) = \{ {F}^{{a}_{{i}_{j}}} {r}_{i} \} ( t ) = \int {B}_{{a}_{{i}_{j}}} ( t , {t}^{′} ) {r}_{i} ( {t}^{′} ) d {t}^{′} \qquad ( 12 )$$

where

$${a}_{{i}_{j}}$$

is the order of the fractional Fourier transformation, and

$${B}_{{a}_{{i}_{j}}}$$

is the kernel of the transformation defined as:

Bαᵢ_{ⱼ}(t,t′)=A_{φ}_{ᵢⱼ} exp [π(t² cot φᵢⱼ−2tt′ csc φᵢ_{ⱼ}+t′² cot φᵢ_{ⱼ})] (13)

where the transformation angle φᵢ_{ⱼ}=αᵢ_{ⱼ}×λ/2, and the scaling constant A_{φi}_{ⱼ} is defined as:

$${A}_{{φ}_{{i}_{j}}} = \frac{exp ( - jπ sgn ( sin {ϕ}_{{i}_{j}} ) / 4 + {jφ}_{{i}_{j}} / 2 )}{{\vert sin {φ}_{{i}_{j}} \vert}^{1 / 2}} \qquad ( 14 )$$

If the order αᵢ_{ⱼ} is chosen as 1, the fractional Fourier transformation corresponds to the ordinary Fourier transformation. Continuous fractional Fourier transformation has very important relationships to both the ambiguity function and the Wigner distribution. The orders αᵢ_{ⱼ} of the fractional Fourier transformations are decided preferably prior to the actual implementation by taking into account the received signal and clutter properties.

In the case of a digital receiver, several algorithms can be utilized to efficiently obtain close approximations to the uniformly spaced samples of the continuous fractional Fourier transform. By using the tabulated algorithm, the following set of discrete fractional Fourier transformations are computed for each of the constructed signal frames:

$${r}_{l , {a}_{{i}_{j}}} [ n ] = \{ \begin{matrix}{\sum }_{{n}^{′}} {B}_{{a}_{{i}_{j}}} [ n , {n}^{′} ] {r}_{l} [ {n}^{′} ] , & \vert {a}_{{i}_{j}} \vert ∈ [ 0.5 , 1.5 ] \\ {\sum }_{{n}^{′}} {B}_{( {a}_{{i}_{j}} - 1 )} [ n , {n}^{′} ] {R}_{i} [ {n}^{′} ] , & \vert {a}_{{i}_{j}} \vert ∈ [ 0 , 0.5 ] ⋃ ( 1.5 , 2 )\end{matrix} \qquad ( 15 )$$

where rᵢ[n] is given in Equation (11) and Rᵢ[n] is the discrete Fourier transform of rᵢ[n] given as

$${R}_{l} [ n ] = \frac{1}{2 B} {\sum }_{{n}^{′}} {r}_{i} [ {n}^{′} ] {e}^{- j \frac{π {nn}^{′}}{2 {( Δ r )}^{2}}} \qquad ( 16 )$$

where Δr is the square root of the time-bandwidth product TB of the signal r̅ᵢ(t). The kernel of the transformation

$${B}_{{a}_{{i}_{j}}} [ n , {n}^{′} ]$$

is defined as:

$${B}_{{a}_{{i}_{j}}} [ n , {n}^{′} ] = \frac{1}{2 Δ r} {A}_{{φ}_{{i}_{j}}} exp [ j \frac{π}{4 {( Δ r )}^{2}} ( {n}^{2} cot {φ}_{{i}_{j}} - 2 {nn}^{′} csc {φ}_{{i}_{j}} + {n}^{′2} cot {φ}_{{i}_{j}} ) ] , \qquad ( 17 )$$

where the transformation angle

$${φ}_{{i}_{j}} = {a}_{{i}_{j}} π / 2 ,$$

and the scaling constant

$${A}_{{φ}_{{i}_{j}}}$$

are defined as in Equation (14). The discrete fractional Fourier transformation has very important relationships to the continuous fractional Fourier transformation, and it can be used to approximate samples of the continuous transformation:

$${r}_{i , {a}_{{i}_{j}}} [ n ] ≅ {r}_{i , {a}_{{i}_{j}}} ( n / ( 2 Δ r ) ) .$$

The above-given form of the discrete fractional Fourier transformation can be computed efficiently by using algorithms that make use of fast Fourier transformation as known in the art. In actual real-time implementations, such a fast computational algorithm preferably is programmed in an integrated chip. The orders of the discrete fractional Fourier transformations can be chosen as in the continuous case by investigating the properties of the received signal and clutter.

The results of the computed fractional Fourier transformations are complex valued signals. By computing their squared magnitudes, they are converted to real valued signals as:

$${s}_{i , {a}_{{i}_{j}} , 2} ( t ) = {\vert {s}_{t , {a}_{{i}_{j}}} ( t ) \vert}^{2}$$

$${r}_{i , {a}_{{i}_{j}} , 2} ( t ) = {\vert {r}_{t , {a}_{{i}_{j}}} ( t ) \vert}^{2} .$$

Then, the correlation between the obtained

$${s}_{i , {a}_{{i}_{j}} , 2}$$

and

$${r}_{i , {a}_{{i}_{j}} , 2}$$

is computed as:

$$\begin{matrix}{c}_{{i}_{j}} ( ρ ) = corr ( {r}_{l , {a}_{{i}_{j}} , 2} ( ρ ) , {s}_{l , {a}_{{i}_{j}} , 2} ( ρ ) ) \\ = \int {r}_{l , {a}_{i} , 2} ( ρ + t ) , {s}_{l , {a}_{i} , 2}^{*} ( t ) d t \\ = \int {\vert {r}_{l , {a}_{ij}} ( ρ + t ) \vert}^{2} {\vert {S}_{l , {a}_{{i}_{j}}} ( t ) \vert}^{2} d t .\end{matrix} \qquad ( 19 )$$

Finally, correlation results are obtained to identify the presence of peaks above the expected noise floor. Projections of the magnitude squared ambiguity function are used to detect the presence of an object. These projections are defined as:

Pᵣ_{ᵢ}_{,s}_{ᵢ}(ρ,φᵢ_{ⱼ})=∫|Aᵣ_{ᵢ}_{,s}_{ᵢ}(ρ cos φᵢ_{ⱼ}−μ sin φᵢ_{ⱼ}, ρ sin φᵢ_{ⱼ}+μ cos φᵢ_{ⱼ})|²dμ, (20)

where ρ is the projection domain variable and φᵢ_{ⱼ} is the projection angle.

A simplified form for the expression in Equation (20) can be obtained by using the following rotation property relating the ambiguity function and the fractional Fourier transformation:

$${A}_{{r}_{j} , {s}_{i}} ( ρ cos {φ}_{{i}_{j}} ) - u sin {φ}_{{i}_{j}} , ρ sin {φ}_{{i}_{j}} + u cos {φ}_{{i}_{j}} = {A}_{{r}_{i , {a}_{{i}_{j}}} , {s}_{i , {a}_{{i}_{j}}}} ( ρ , u ) , \qquad ( 21 )$$

where

$${r}_{i , {a}_{{i}_{j}}} ( t )$$

and

$${s}_{i , {a}_{{i}_{j}}} ( t )$$

are the (αᵢⱼ)^{th} order fractional Fourier transforms of rᵢ(t) and sᵢ(t). This property of the fractional Fourier transform essentially means that the ambiguity function of the fractional Fourier transformed signals

$${A}_{{r}_{i , {a}_{{i}_{j}}} , {s}_{i , {a}_{{i}_{j}}}}$$

is the same as the rotated ambiguity function Aᵣ_{ᵢ}_{,s}_{ᵢ}, with an angle of rotation equal to the transformation angle φᵢ_{ⱼ}.

This relationship can be obtained from the following well-known rotation property between the Wigner distribution and the fractional Fourier transformation

$${W}_{{r}_{i}} ( ρ cos {φ}_{{i}_{j}} - u sin {φ}_{{i}_{j}} , ρ sin {φ}_{{i}_{j}} + u cos {φ}_{{i}_{j}} ) = {W}_{{r}_{i , {a}_{{i}_{j}}}} ( ρ , u ) . \qquad ( 22 )$$

First, this well known rotation property for auto-Wigner distribution is generalized to the cross-Wigner distribution:

$${W}_{{r}_{i} , {s}_{j}} ( ρcos {φ}_{{i}_{j}} - u sin {φ}_{{i}_{j}} , ρsin {φ}_{{i}_{j}} + u cos {φ}_{{i}_{j}} ) = {W}_{{r}_{i , {a}_{{i}_{j}}} , {s}_{i , {a}_{{i}_{j}}}} ( ρ , u ) . \qquad ( 23 )$$

Then, by using the fact that there is a 2-D Fourier relation between the cross-ambiguity function and the cross-Wigner distribution, and by recalling that 2-D Fourier transform of a rotated signal is the same as the rotated 2-D Fourier transform of the original, the relation in Equation (21) can be obtained.

Thus by using the rotation property given in Equation (21), the projection given in Equation (20) can be written as

$${P}_{{r}_{l} , {s}_{l}} ( ρ , {φ}_{{i}_{j}} ) = \int {\vert {A}_{{r}_{l , {a}_{{i}_{j}}} , {a}_{l {,}_{{a}_{{i}_{j}}}}} ( ρ , u ) \vert}^{2} d u , \qquad ( 24 )$$

in terms of the fractional Fourier transforms

$${r}_{i , {a}_{{i}_{j}}} ( t )$$

and

$${s}_{i , {a}_{{i}_{j}}} ( t )$$

Then, by using the definition of the cross-ambiguity function in Equation (16), the projection given by Equation (24) can be written as:

$$\begin{matrix}{P}_{{r}_{l}} {,}_{{s}_{l}} ( ρ , {φ}_{{i}_{j}} ) = \int \int \int {r}_{i , {a}_{{i}_{j}}} ( {t}^{′} + ρ / 2 ) {s}_{l , {a}_{{i}_{j}}}^{*} ( {t}^{′} - ρ / 2 ) {r}_{l , {a}_{{i}_{j}}}^{*} ( {t}^{″} + ρ / 2 ) \\ {s}_{l , {a}_{{i}_{j}}} ( {t}^{″} - ρ / 2 ) {e}^{j2π n ( {t}^{′} - {t}^{″} )} d {t}^{′} d {t}^{″} d u \\ = \int \int {r}_{l , {a}_{{i}_{j}}} ( {t}^{′} + ρ / 2 ) {s}_{l , {a}_{{i}_{j}}}^{*} ( {t}^{′} - ρ / 2 ) {r}_{l , {a}_{{i}_{j}}}^{*} ( {t}^{″} + ρ / 2 ) \\ {s}_{l , {a}_{{i}_{j}}} ( {t}^{″} - ρ / 2 ) δ ( {t}^{′} - {t}^{″} ) d {t}^{′} d {t}^{″} ,\end{matrix} \qquad ( 25 )$$

where δ(t) is the Dirac-delta function. Then, by using the sifting property of the Dirac-delta function, the expression for the projection can be simplified into:

$${P}_{{r}_{l}} {,}_{{s}_{l}} ( ρ , {φ}_{{i}_{j}} ) = \int {\vert {r}_{l , {a}_{{i}_{j}}} ( {t}^{′} + ρ / 2 ) \vert}^{2} {\vert {s}_{l , {a}_{{i}_{j}}} ( {t}^{′} - ρ / 2 ) \vert}^{2} d {t}^{′} . \qquad ( 26 )$$

Finally, by changing the variable of integration with t+ρ/2, the expression for the projection given by Equation (26) can be expressed as:

$$\begin{matrix}{P}_{{r}_{l} , {s}_{l}} ( ρ , {φ}_{{i}_{j}} ) = \int {\vert {r}_{l , {a}_{{i}_{j}}} ( t + ρ ) \vert}^{2} {\vert {s}_{l , {a}_{{i}_{j}}} ( t ) \vert}^{2} d t \\ = corr ( {r}_{l , {a}_{{i}_{j}}} {,}_{2} ( ρ ) , {s}_{l , {a}_{{i}_{j}}} {,}_{2} ( ρ ) ) .\end{matrix} \qquad ( 27 )$$

In this final form, the required projection is the same as the correlation of

$${r}_{i , {a}_{{i}_{j}} , 2} ( ρ )$$

and

$${s}_{i , {a}_{{i}_{j}} , 2} ( ρ ) .$$

Thus, the computed correlation cᵢ_{ⱼ}(ρ) in Equation (19) is the desired projection Pᵣ_{ᵢ}_{·s}_{ᵢ}(ρ,φᵢ_{ⱼ}).

Similarly, for a digital receiver the required projections can be approximated as:

$$\begin{matrix}{P}_{{r}_{l} {s}_{l}} ( m / ( 2 Δ r ) , {φ}_{{i}_{j}} ) ≅ 1 / ( 2 Δ r ) {\sum }_{n} {\vert {r}_{i , {a}_{{i}_{j}}} ( ( n + m ) / ( 2 Δ r ) ) \vert}^{2} \\ {\vert {s}_{l , {a}_{{i}_{j}}} ( n / ( 2 Δr ) ) \vert}^{2} \\ ≅ 1 / ( 2 Δ r ) {\sum }_{n} {\vert {r}_{l , {a}_{{i}_{j}}} [ n + m ] \vert}^{2} {\vert {s}_{l , {a}_{{i}_{j}}} [ n ] \vert}^{2} \\ = 1 / ( 2 Δ r ) corr {\vert {r}_{l , {a}_{{i}_{j}}} [ m ] \vert}^{2} , {\vert {s}_{l , {a}_{{i}_{j}}} [ m ] \vert}^{2} ) ,\end{matrix} \qquad ( 28 )$$

where

$${r}_{i , {a}_{{i}_{j}}} [ n ]$$

and

$${s}_{i , {a}_{{i}_{j}}} [ n ]$$

are the discrete fractional Fourier transformations given by Equation (15).

Although the above equations for both continuous and discrete signals result in expressions that are projections of magnitude squared cross-ambiguity function, it should be understood that the terms “projection of the cross-ambiguity function” and simply “projection” as used in this disclosure refer to a projection of magnitude square cross-ambiguity function and are used interchangeably through out the application. Additionally, in this disclosure, the term “amplitude” of an ambiguity function refers to both the complex amplitude and magnitude of the ambiguity function, which is the absolute value of the complex amplitude.

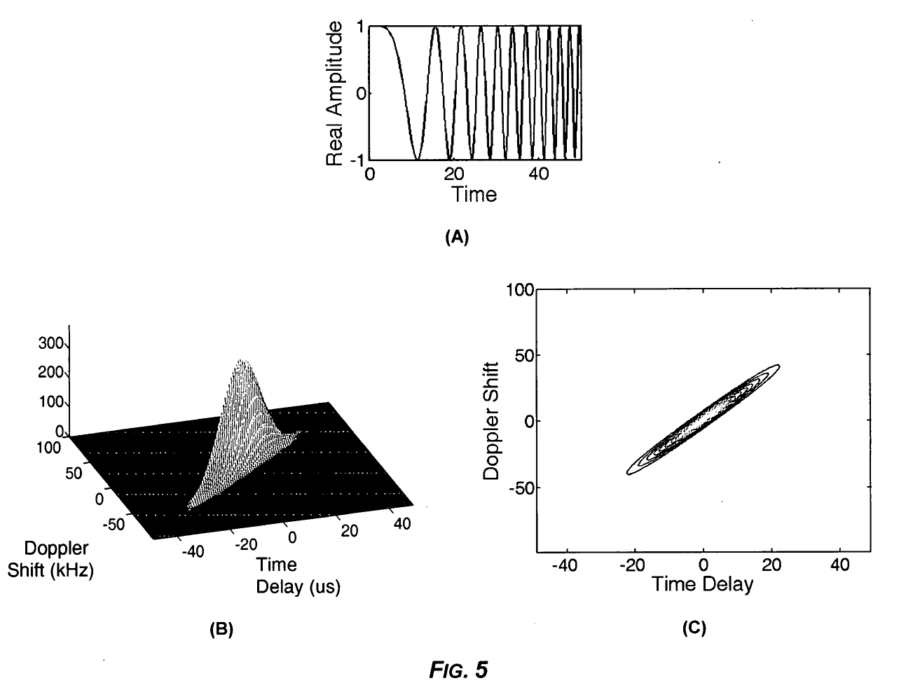

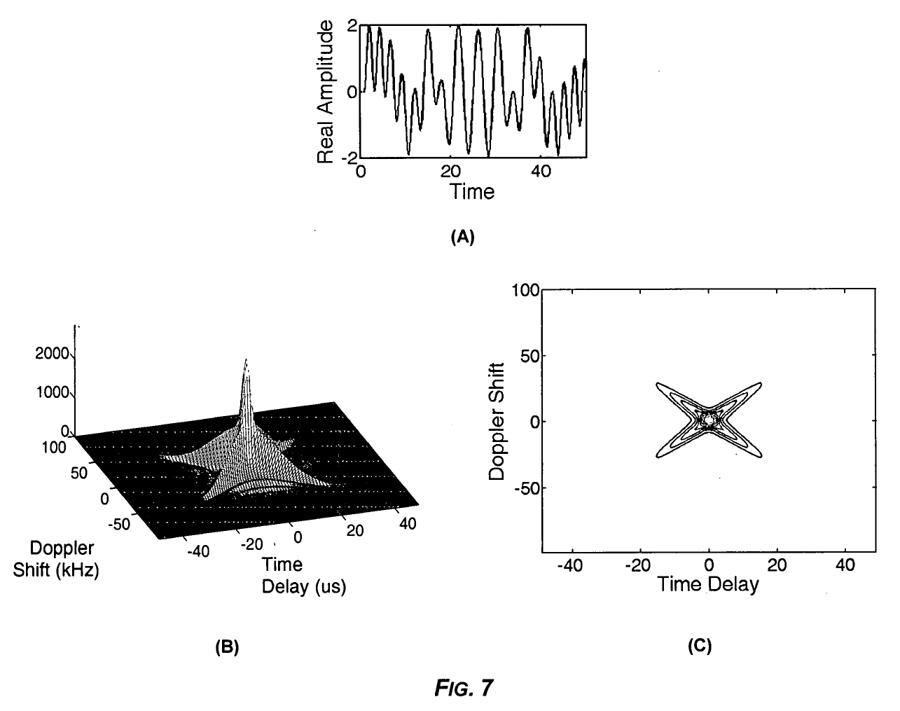

The detection methods in this disclosure rely on cross-ambiguity functions that have ridges. The term “curve” of the cross-ambiguity function as used in this disclosure refers to a 2D curve in the Doppler shift/time delay plane of the cross-ambiguity function that corresponds to the ridge of the 3D profile of the cross-ambiguity function surface of the transmitted signal and the received signal collapsed onto the Doppler-shift/time delay plane. Note that the term curve as used in this disclosure refers to line segments and other geometric curves, such as an “S”-shape. FIGS. 5B and 5C show a cross-ambiguity function of a signal and its curve in the cross-ambiguity function Doppler shift/time delay plane, respectively. An ambiguity function may have multiple curves. For example, FIG. 7B shows 3D profile of cross-shaped 3D profile; FIG. 7C shows two curves of that ambiguity function. In the present disclosure, the term “curve” is associated with 2D Doppler-shift/time delay plane; the term “ridge” is associated with a 3D Doppler-shift/time delay/amplitude domain.

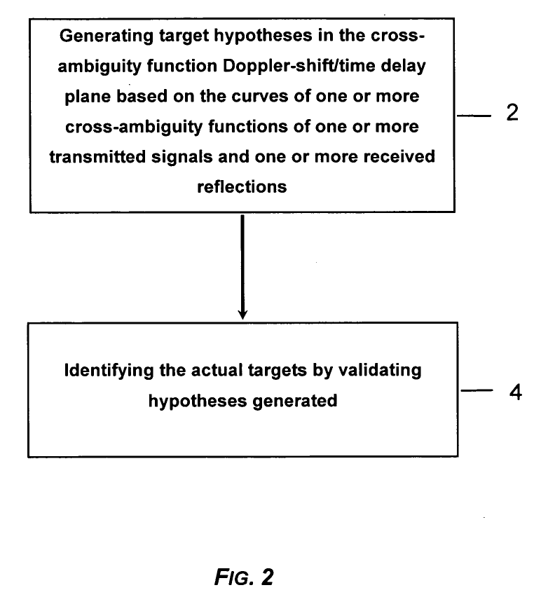

FIG. 2 illustrates the flow chart of the target detection method. Generally, in step 2, target hypotheses in the Doppler-shift/time delay plane based on the curves of one or more cross-ambiguity functions of one or more transmitted signals and one or more received signals are generated. In step 4, the actual targets are identified by validating hypotheses generated in step 2.

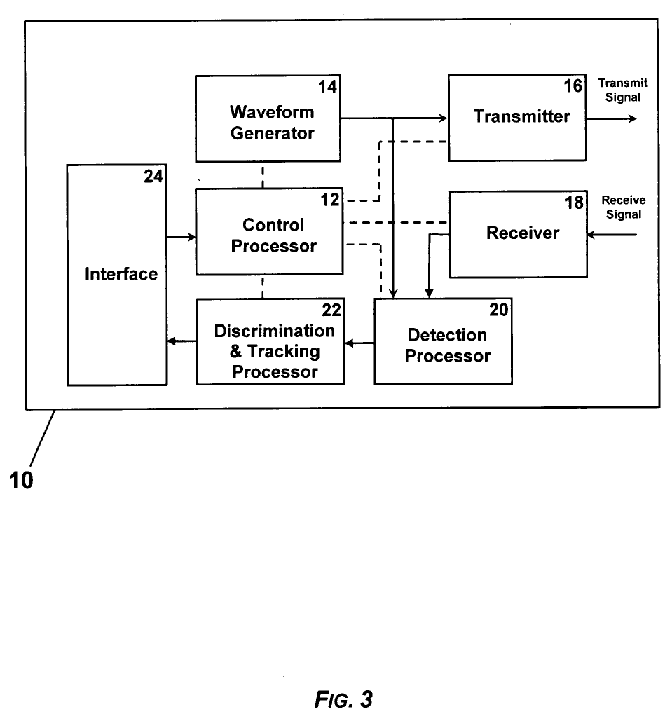

FIG. 3 shows sensor system 10 for performing the target detection method. Control processor 12 controls the operation of all other components of sensor system 10. Preferably, waveform generator 14 produces digital samples which collectively define the waveform of the signal transmitted by the sensor system 10. The digital samples may be generated by a computer program that produces a sequence of samples that represents a desired waveform. Alternatively, the samples representing a desired waveform are retrieved from memory where they have been stored previously. Control processor 12 provides necessary instructions for generating or selecting the samples of the desired waveform. Waveform generator 14 communicates the generated waveform to transmitter 16 and to detection processor 20. In some embodiments, waveform generator 14 produces analog waveforms. Although the signal that is actually transmitted on the transmission medium is different from the waveform generated by waveform generator 14, for purposes of this disclosure, the output of the waveform generator 14 is referred to as the transmitted signal, sₓ(t).

Transmitter 16 converts the transmitted signal outputted by waveform generator 14 to analog format, amplifies it to and then emits the processed signal over a transmission medium, as known in the art. Transmitter 16 is preferably a radio frequency signal transmitter, but may also be an optical signal or an acoustic signal transmitter. Receiver 18 receives signals from the transmission medium, amplifies the signals to the working levels, and optionally frequency converts and digitizes the signal, as known in the art. Signals received by receiver 18 include reflections from objects or interfering objects, such as clutter and multi-path, noise, jamming, etc. For the purposes of this disclosure, the signal that is the outputted by receiver 18 is referred to as the received signal, rₓ(t).

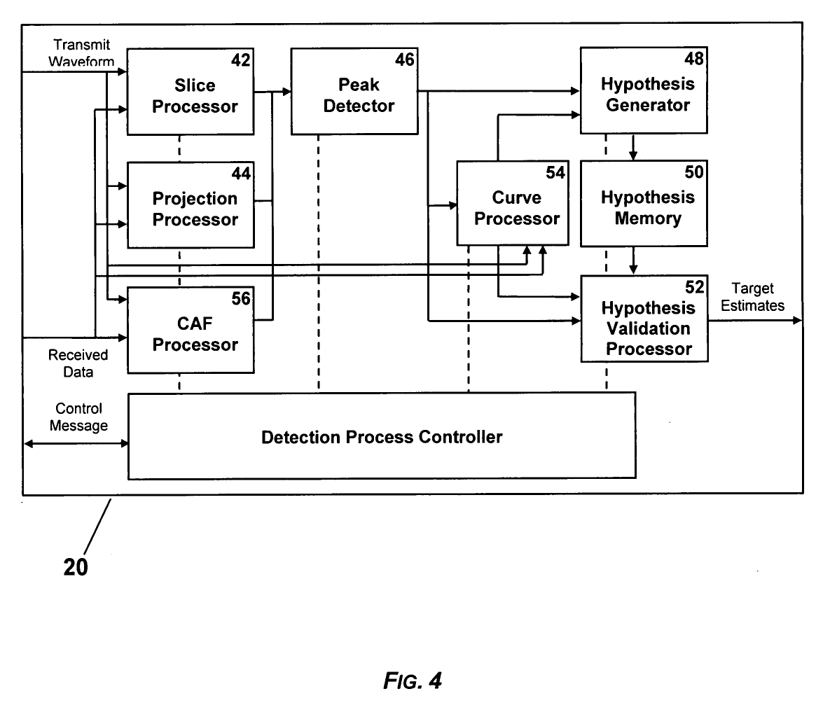

Detection processor 20 processes one or more transmitted signals from waveform generator 14 and one or more received and pre-processed signals from receiver 18. Detection processor 20 determines the existence of targets, generates target hypotheses, and detects actual targets. Detecting targets refers to determining the presence of a target and estimating one or more parameters, such as Doppler shift and time delay in the ambiguity domain, which correspond to radial velocity and distance, respectively. Detection processor 20 is shown in more detail in FIG. 4 and described below. Output of detection processor 20 is passed to discrimination and tracking processor 22.

Discrimination and tracking processor 22 receives detected target parameters from detecting processor 20 and determines the nature of the targets (i.e., whether the target is a plane, a decoy missile, a bird, etc.) and the trajectory of the target. Interface 24 may be a human user interface, such as a monitor, keyboard, and mouse, or it can be an interface to another system, such as a system controlling and receiving data from multiple sensor systems similar to sensor system 10.

FIG. 4 shows detection processor 20 in greater detail. Detection processor 20 receives as inputs the transmitted signal from waveform generator 14 and the received signal from receiver 18. It is understood by persons of ordinary skill in the art that the generated waveform may also be pre-processed by amplification, frequency shifting, and other techniques, which are known in the art.

Detection process controller 58 configures, controls the operation of, and supplies data to, other components of detection processor 20. Detection process controller 58 also receives status and operational parameters from each component of detection processor 20.

Slice processor 42 computes a slice of the cross-ambiguity function of the transmitted signal and the received signal. The line segment over which the slice is computed is given by two or more of the following parameters: the slice start coordinate, the slice end coordinate, the length of the slice, and the angel of the slice, which are supplied to slice processor 42 by detection process controller 58. Projection processor 44 computes a projection of the cross-ambiguity function of the transmitted signal and the received signal. The path of integration for the projection is provided by detection process controller 58. CAF processor 56 computes the cross-ambiguity function of the transmitted signal and the received signal for the Doppler-shift/time delay coordinates supplied by detection process controller 58. Note that slice processor 42, projection processor 44, and CAF processor 56 accomplish their respective tasks without computing the entire cross-ambiguity function. Detection process controller 58 determines which of these elements perform their respective functions and when.

Peak detector 46 determines coordinates of one or more peaks on the slice or projection or the portion of the cross-ambiguity function, computed by slice processor 42, projection processor 44, or CAF processor 56, respectively. Peak detector 46 preferably operates by comparing values to a threshold. Peak detector 46 only reports a finding of a peak to other components if the peak exceeds a predetermined threshold.

Curve processor 54 extrapolates curves of the cross-ambiguity function of the transmitted signals and the received signals. The extrapolation of the curves may be implemented differently depending on the curve. In the preferred embodiment curve processor determines equations of lines in the Doppler-shift/time delay plane over which the curves lie based on the slope of the curve and a point on the curve that is identified by slice processor 42 or a projected point of the curve that is identified by projection processor 44 as described below. Other more complex extrapolations are also contemplated. Preferably curve processor has a memory that stores curves of ambiguity functions. Curve processor 54 can easily determine the curve of a particular transmitted signal. Alternatively, curve processor 54, or another element, may compute auto-ambiguity function of a signal and its curve in real time. Hypothesis generator 48 generates Doppler-shift/time delay coordinates of hypothetical targets, which are referred to as target hypotheses. Hypothesis memory 50 stores these target hypotheses. Hypothesis validation processor 52 receives input from peak detector 46 and from target hypothesis memory 50. Hypothesis validation processor 52 analyzes each of the identified target hypotheses and determines which hypothesis is an actual target.

It is known in the art that the auto-ambiguity function of a signal may be used to predict general characteristics of the cross-ambiguity function of that signal and its reflection form a target. For example, if the auto-ambiguity function of linear frequency modulated (LFM) signal has a ridge, then the cross-ambiguity function of this signal and its reflection from a target also has a ridge. The position of the ridge in the cross-ambiguity function Doppler-shift/time delay plane is dictated by the radial velocity of the target and its distance from the sensor system. It is presumed that signals used for target detection are analyzed in advance and their auto-ambiguity functions are known. Respective curves of the cross-ambiguity functions are therefore also known, however, their locations in the cross-ambiguity function Doppler-shift/time delay plane are unknown.

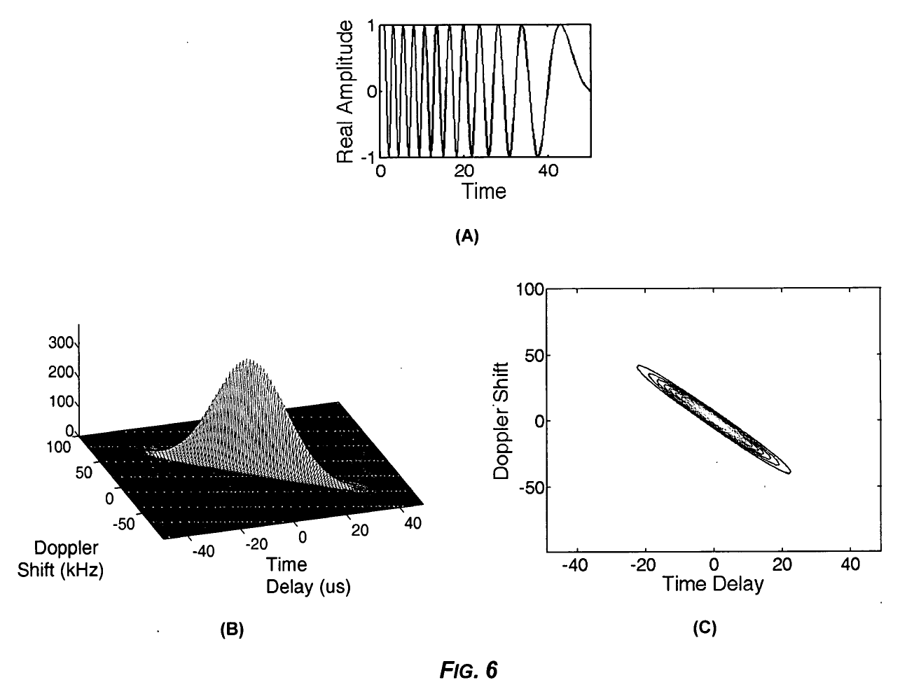

Signals used for target detection process may be simple signals, having a single ridge, such as an LFM signal having an increasing frequency chirp or composite signals, having multiple ridges, such as a two LFM composite signal, one LFM having an increasing frequency chirp, and another LFM having a decreasing frequency chirp. FIG. 5A shows an LFM signal having an increasing frequency chirp in time domain; FIG. 5B shows the 3D profile of its auto-ambiguity function; and FIG. 5C shows its curve in the auto-ambiguity function Doppler-shift/time delay plane. FIGS. 6A-6C show an LFM signal having a decreasing frequency chirp in time domain; the 3D profile of its auto-ambiguity function; and its curve in the auto-ambiguity function Doppler-shift/time delay plane, respectively. FIG. 7A shows a two LFM composite signal having both an increasing and a decreasing frequency chirp in time domain; FIG. 7B shows its 3D profile of its auto-ambiguity function; and FIG. 7C shows its curve in the auto-ambiguity function Doppler-shift/time delay plane, which is a cross, in other words two linear curves.

In the preferred embodiment, signals used for the hypothesis generation portion of the detection process of step 2 in FIG. 2 have auto-ambiguity functions with linear ridges, as shown in FIGS. 5A-5C, 6A -6C, and 7A-7C. By using more complex extrapolation methods, the detection process may also make use of signals that do not necessarily have auto-ambiguity functions with linear ridges. As mentioned above, cross-ambiguity functions of the signals used in the preferred embodiment and their reflections have linear ridges and therefore their auto-ambiguity functions have one or more linear curves. Equations of one or more lines in the cross-ambiguity function Doppler-shift/time delay plane over which these curves lie are easily computed based on the slope of the curve, which is a line segment, and a point on the curve or a projected point of the curve.

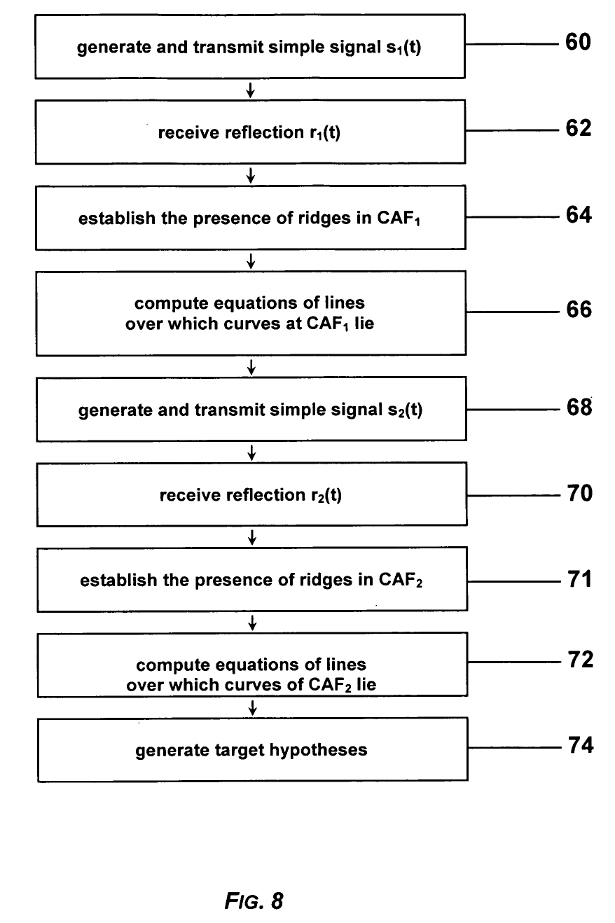

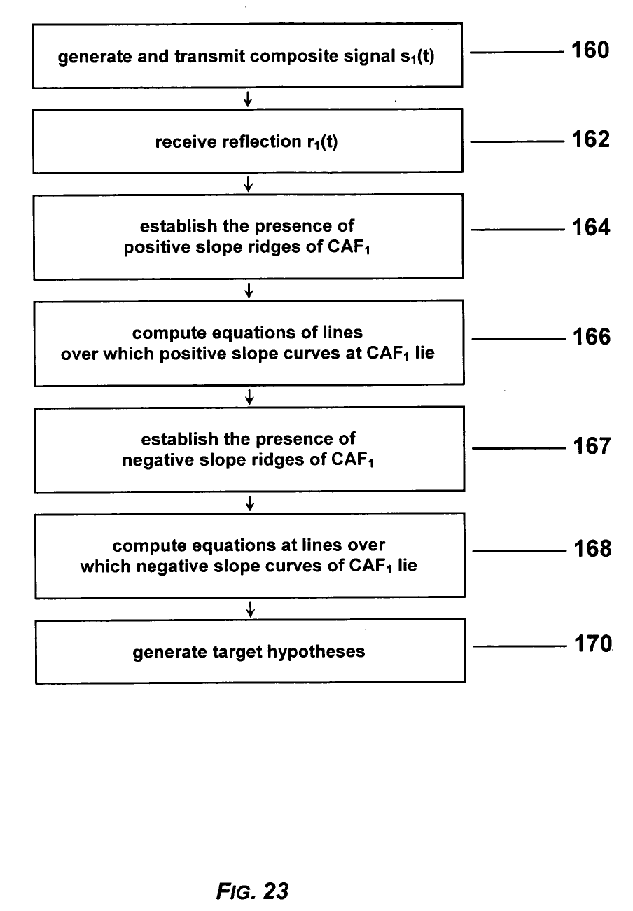

FIGS. 8 and 23 show two embodiments for implementing step 2 in FIG. 2. A person of ordinary skill in the art would understand that there are other multiple embodiments contemplated by this disclosure. FIG. 8 shows steps performed for accomplishing step 2 in FIG. 2, namely generating target hypotheses of targets in the Doppler-shift/time delay plane using simple signals. Specifically, in step 60, waveform generator 14 generates samples corresponding to a desired waveform and transmitter 16 transmits signal s₁(t) based on the generated samples. In step 62, receiver 18 receives signal r₁(t) and preprocesses it. In step 64, detection processor 20 establishes the presence of one or more ridges of the cross-ambiguity function of s₁(t) and r₁(t), the first cross-ambiguity function.

Establishing the presence of one or more ridges in step 64 may be accomplished by computing a slice of the first cross-ambiguity function with slice processor 42 or computing a projection of the first cross-ambiguity function with projection processor 44. In embodiments that use slice processor 42 to establish the presence of one or more ridges, a slice is computed at an angle known to intercept the one or more curves of the first cross-ambiguity function in the Doppler-shift/time delay plane. Subsequently, peak detector 46 analyzes the computed slice, which reveals one or more peaks corresponding to the ridges of the cross-ambiguity function. The presence of one or more peaks on the slice signifies the presence of one or more ridges of the first cross-ambiguity function, and consequently, one or more targets on each ridge.

Similarly, in embodiments that use projection processor 44 to establish the presence of one or more ridges of the first cross-ambiguity function, a projection is computed along the path of integration, oriented at an angle in the cross-ambiguity function Doppler-shift/time delay plane known to produce projection peaks in the presence of targets for the selected transmitted signal s₁(t) based on the curve of its auto-ambiguity function. Subsequently peak detector 46 analyzes the computed projection, which reveals one or more peaks corresponding to the ridges of the first cross-ambiguity function. The presence of one or more peaks on the projection signifies the presence of one or more ridges of the first cross-ambiguity function, and consequently, one or more targets on each ridge.

Note that in step 64 only the presence of one or more ridges of the cross-ambiguity function is established. No conclusions can necessarily be drawn as to locations of targets in the cross-ambiguity function Doppler-shift/time delay plane or even the number of targets. Even if the presence of only a single ridge is established two or more targets may be present and lying on the same ridge of the cross-ambiguity function.

In step 66, for each ridge of the first cross-ambiguity function, curve processor 54 computes the equation of the line in the Doppler-shift/time delay plane over which the curve of the first cross-ambiguity function lies. In embodiments that use a slice to establish the presence of ridges, a peak on the slice identifies a point in the Doppler-shift/time delay plane; the slope of the line is the same as the slope of the curve, which is known in advance from the selection of s₁(t). In embodiments that use a projection to establish the presence of ridges, a peak on the axis of the projection corresponds to a specific line that is parallel to, and intersects a curve in the Doppler shift/time delay plane.

In particular, in case of a slice, the equation of the line over which the slice is computed may be defined in a number of ways. As explained above, the slice may be thought of as a collection of samples over that line. After peak detector 46 determined which slice sample is a peak, the coordinates of the peak in the cross-ambiguity function Doppler-shift/time delay plane may be easily derived. For example, if the line over which the slice is computed is given by two points, the equation of that line may be easily computed, and the coordinates of a sample of the slice having a peak, expressed in the sample number, may be converted in Doppler-shift and time delay as known in the art. Multiple Doppler-shift/time delay coordinates for multiple peaks on the slice may also be determined.

In case of a projection, the projection path over which the integration is performed is given by a point, ρ₀, (which may or may not be the origin of the Doppler-shift/time delay plane) and an angle. After a projection has been computed, peak detector 46 determines that there is a peak on the axis of the projection corresponding to the ridge expressed in distance Δρ from ρ₀=0, which can be positive or negative. The peak's Doppler-shift coordinate is given by the Doppler-shift coordinate of ρ₀+Δρ sin φ, and the peak's time delay coordinate is given by time delay coordinate of ρ₀+Δρ cos φ. Multiple coordinates for multiple peaks on the projection may also be determined.

Regardless of whether slice processor 42 or projection processor 44 is used, the obtained information is sufficient to identify a point in the cross-ambiguity function Doppler-shift/time delay plane on a line over which the curve of the first cross-ambiguity function lies, for each curve. Determining an equation of a line with a known slope passing through a point is well known in the art. Curve processor 54 determines one or more equations f_{1.1}(d) . . . f_{1.n}(d) of lines in the cross-ambiguity function Doppler-shift/time delay plane over which curves of the first cross-ambiguity function lie.

In step 68, waveform generator 14 generates samples corresponding to a desired waveform and transmitter 16 transmits signal s₂(t) based on the generated samples. s₂(t) is selected so that the slope of the curve of its auto-ambiguity function in the Doppler-shift/time delay plane is different from the slope of the auto-ambiguity function of s₁(t) in the Doppler-shift/time delay plane. Preferably, s₂(t) is selected so that the slope of the curve of its auto-ambiguity function in the Doppler-shift/time delay plane is substantially perpendicular to the curve of the auto-ambiguity function of s₁(t) in the Doppler-shift/time delay plane.

In step 70, receiver 18 receives signal r₂(t) and preprocesses it. In step 71, detection processor 20 establishes the presence of one or more ridges of the cross-ambiguity function of s₂(i) and r₂(t), the second cross-ambiguity function. This may be accomplished by computing a slice of the second cross-ambiguity function with slice processor 42 or computing a projection of the second cross-ambiguity function with projection processor 44, as disclosed above.

In step 72, similarly to step 66, for each ridge of the second cross-ambiguity function, curve processor 54 computes the equation of the line in the cross-ambiguity function Doppler-shift/time delay plane over which the curve of the second cross-ambiguity function lies. In embodiments that use a slice to establish the presence of ridges, a peak on the slice identifies a point in the Doppler-shift/time delay plane; the slope of the line is the same as the slope of the curve, which is known in advance from the selection of s₂(t). In embodiments that use a projection to establish the presence of one or more ridges, a peak on the axis of the projection is sufficient to determine the coordinates in the Doppler-shift/time delay plane of a point on the line over which the curve of the second cross-ambiguity function lies. Determining an equation of a line with a known slope passing through a point is well known in the art. Curve processor 54 determines one or more equations f_{2.1}(d) . . . f_{2.n}(d) of lines over which curves of the second cross-ambiguity function lie.

In step 74, hypothesis generator 48 generates target hypotheses. In the preferred embodiment, generating target hypotheses, is computing points of intersection of f_{1.1}(d) . . . f_{1.n}(d) and f_{2.1}(d) . . . f_{2.n}(d). Computing intersection points of a pair of lines may be accomplished by solving a system of two linear equations, which is well known in the art.

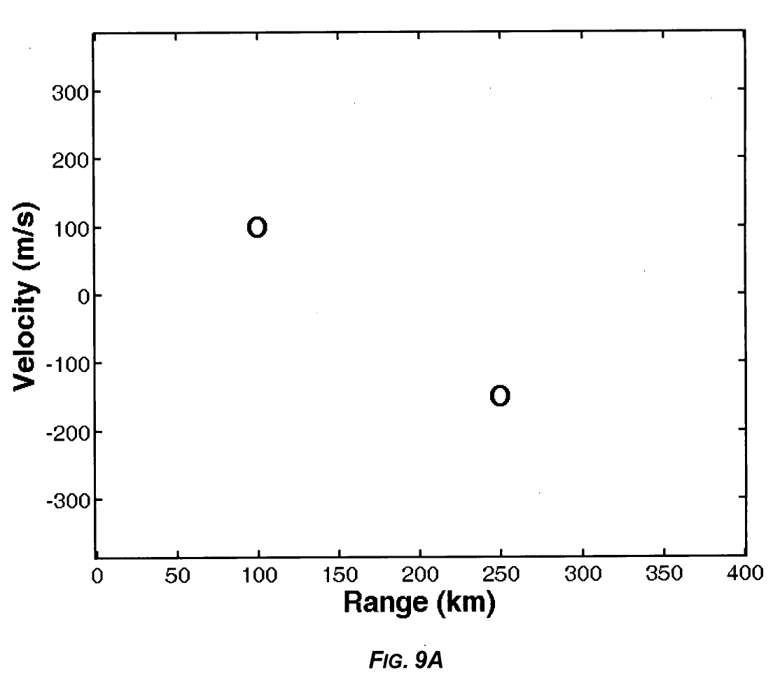

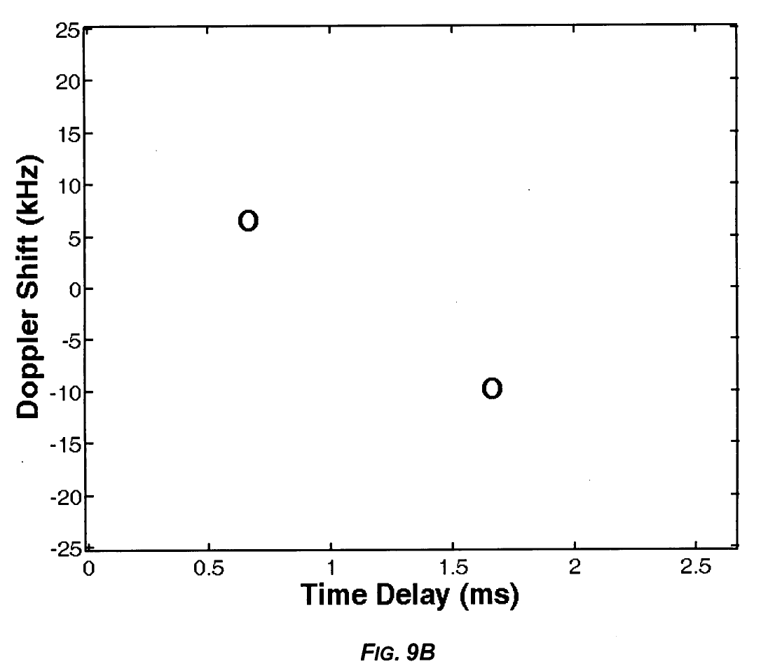

The above method of generating hypotheses using simple signals is best illustrated with an example. FIG. 9A shows two targets in the velocity/range domain. One target is 100 km from the sensor system moving with radial velocity of 100 m/s toward the sensor system. Another target is at 250 km from the sensor system moving with radial velocity of 150 m/s away from the sensor system. FIG. 9B shows the same two targets in the Doppler-shift/time delay plane. Turning back to FIG. 8, in step 60, waveform generator 14 generates samples corresponding to a desired waveform s₁(t). In this example, the waveform is a linear frequency modulation (LFM) waveform with increasing frequency chirp, which has the auto ambiguity function with a linear ridge, whose curve is a positive slope line segment in the Doppler-shift/time delay plane, such as shown in FIGS. 5B and 5C. Transmitter 16 processes and transmits signal s₁(t) based on the generated samples. The rate of frequency increase in signal s₁(t) determines the slope of the curve in the auto-ambiguity function Doppler-shift/time delay plane. Preferably, curve processor 54 has information about the curve of s₁(t) auto-ambiguity function, which, in this example, is a line segment. In step 62, receiver 18 receives signal r₁(t) and preprocesses it.

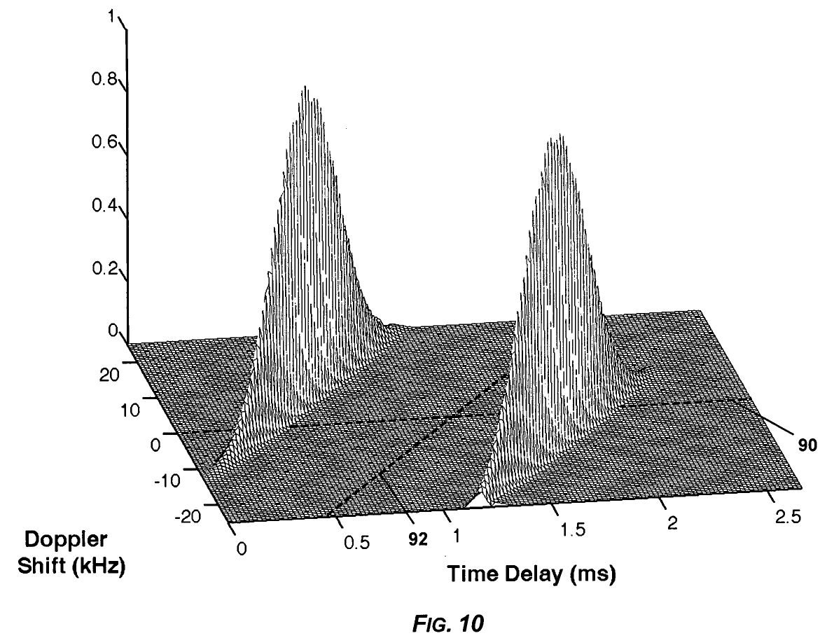

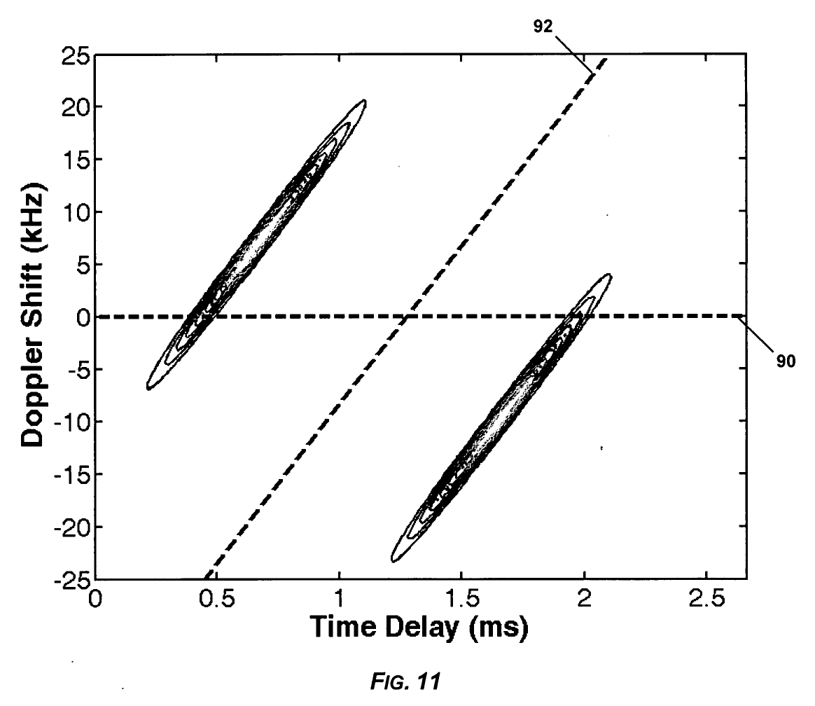

In step 64, detection processor 20 establishes the presence of one or more ridges in the cross-ambiguity function of s₁(t) and r₁(t), the first cross-ambiguity function. In this example, a slice of the cross-ambiguity function of the first cross-ambiguity, is computed. Because the ridges of the first cross-ambiguity function are known to have a positive slope, computing a slice at a zero angle in the Doppler-shift/time delay plane ensures that the slice intercepts the ridges. Alternatively, the slice may be computed along a line that is oblique or perpendicular to the curve of the first cross-ambiguity function. FIG. 10 shows a 3D profile of the first cross-ambiguity function that results in the presence of the two targets shown in FIG. 9A, if it were computed. FIG. 11 shows a 2D contour plot of the first cross-ambiguity function. Note that the cross-ambiguity function is never actually computed. In the preferred embodiment, establishing the presence of targets in step 64 is accomplished by computing a slice of the cross-ambiguity function along line 90, or any other line known to intersect the curve of the first cross-ambiguity function. In an alternative embodiment, in which step 64 is accomplished by computing a projection, a projection is preferably computed along the path of integration, line 92, substantially parallel to the ridges of the first cross-ambiguity function.

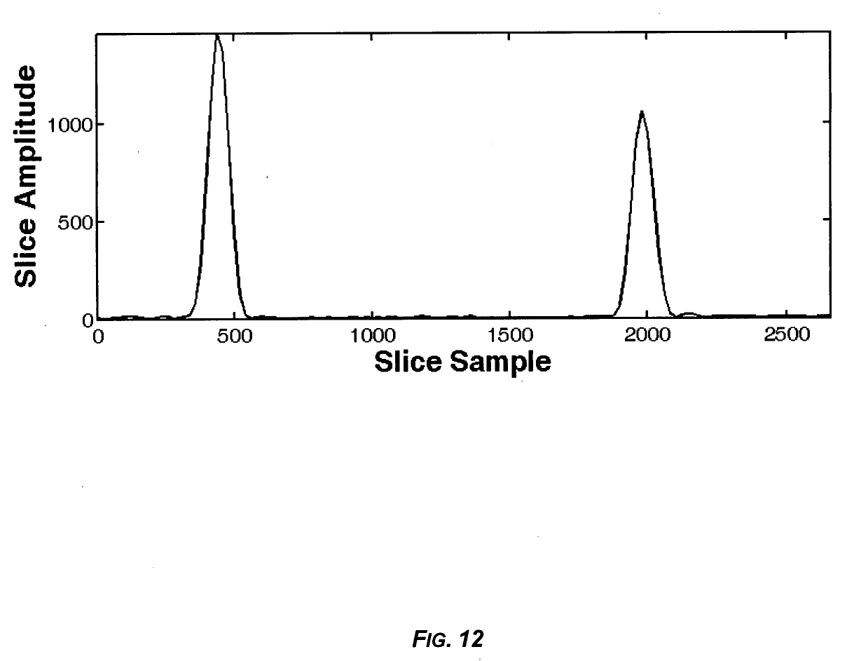

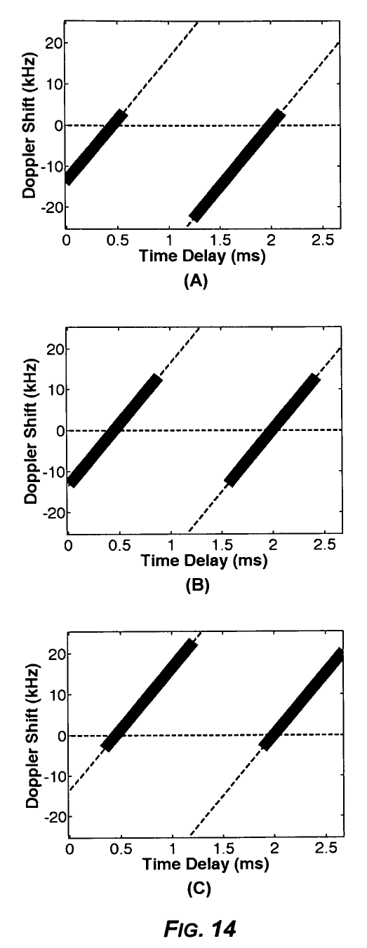

In this example, slice processor 42 computes a slice along line 90. The resulting slice is shown in FIG. 12. As shown in FIG. 12, the slice has two peaks corresponding to the two ridges shown in FIGS. 10 and 11. Because signal s₁(t) was specifically selected to be a linear frequency modulation (LFM) waveform with increasing frequency chirp with specific parameters, its curve in the auto-ambiguity function Doppler-shift/time delay plane is known. However, the locations of one or more curves in the cross-ambiguity function Doppler-shift/time delay plane are unknown. Based on the information provided by the slice, coordinates of one or more points on the cross-ambiguity function Doppler-shift/time delay plane, it is possible that the curves are found in many possible locations in the cross-ambiguity function Doppler-shift/time delay plane while the slice has peaks in the same locations, as shown in FIGS. 14A-14C. As shown in FIGS. 14A-14C, although the locations of the curves of the first cross-ambiguity function may vary, lines on which the curves lie would be the same regardless of the actual location of the curves in the Doppler-shift/time delay plane.

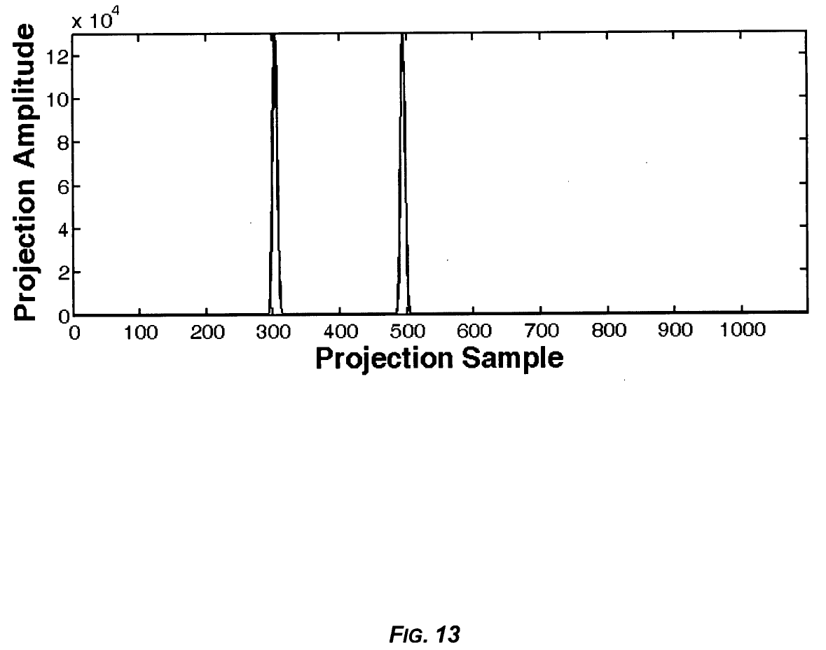

In an alternative embodiment, projection processor 44 computes a projection along path of integration 92. The resulting projection is shown in FIG. 13. As shown in FIG. 13, the projection has two peaks corresponding to the two ridges shown in FIGS. 10 and 11. Steps and computations outlined in connection with FIG. 8 may be performed to determine equations of lines over which the curves of the cross-ambiguity function lie in the Doppler-shift/time delay plane.

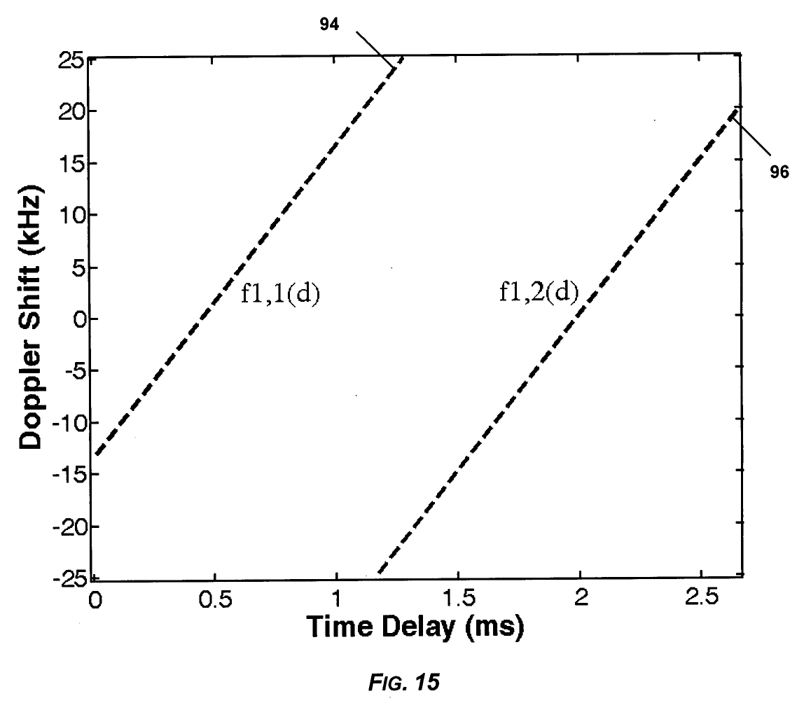

Regardless of whether a slice or projection is used to establish the presence of ridges of the cross-ambiguity function of s₁(t) and r₁(t), the information gathered in step 64 is sufficient to compute equations of lines over which the curves of the first cross-ambiguity function lie in the Doppler-shift/time delay plane. As mentioned above, the slope of lines corresponding to all curves of the first cross-ambiguity function is the same and it is known from the curve of the auto-ambiguity function of s₁(t). Based on this information, in step 66, curve processor 54 computes equations f_{1.1}(d) and f_{1.2}(d) of two lines 94, 96 shown in FIG. 15 in the cross-ambiguity function Doppler-shift/time delay plane over which the curves of the first cross-ambiguity function lie.

In step 68, waveform generator 14 generates samples corresponding to a desired waveform s₂(t). In this example, the desired waveform is a linear frequency modulation (LFM) waveform with decreasing frequency chirp, which has the auto ambiguity function with a linear ridge, whose curve is a negative slope line segment in the auto-ambiguity function Doppler-shift/time delay plane, such as shown in FIGS. 6B and 6C. Transmitter 16 processes and transmits signal s₂(t) based on the generated samples. The rate of frequency decrease in signal s₂(t) determines the slope of the line segment in the Doppler-shift/time delay plane. In step 70, receiver 18 receives signal r₂(t) and preprocesses it.

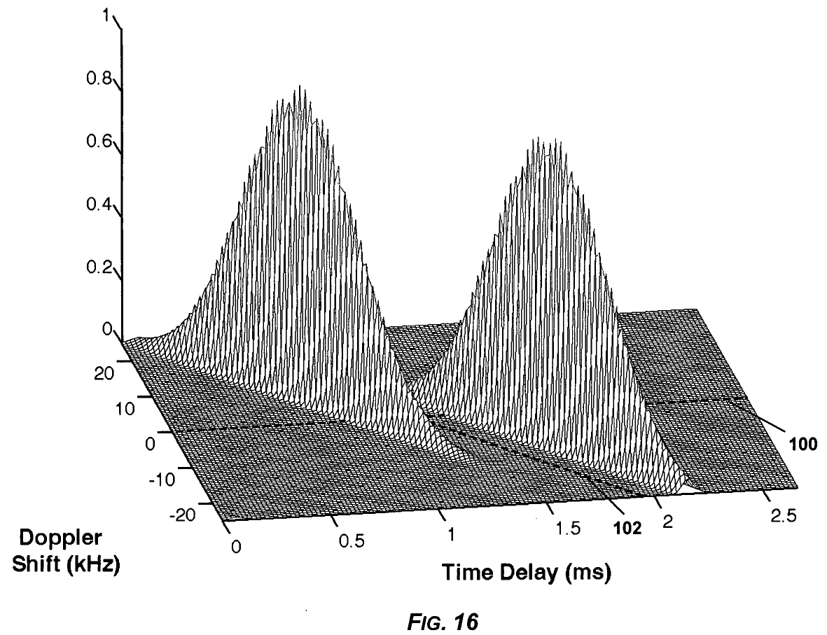

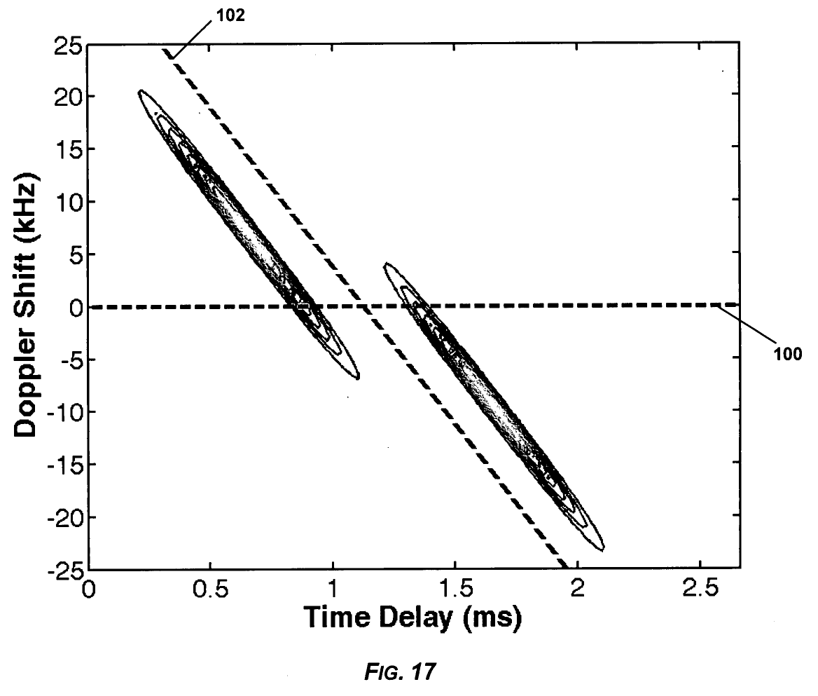

In step 71, detection processor 20 establishes the presence of one or more ridges of the cross-ambiguity function of s₂(t) and r₂(t), the second cross-ambiguity function. In this example, a slice of the second cross-ambiguity function is computed. Because the ridges of the second cross-ambiguity function are known to have a negative slope, computing a slice at a zero angle in the Doppler-shift/time delay plane ensures that the slice intercepts the ridges. Alternatively, the slice may be computed along a line that is oblique or perpendicular to the curve of the second cross-ambiguity function. FIG. 16 shows a 3D profile of the second cross-ambiguity function that results in the presence of the two targets shown in FIG. 9A, if it were computed. FIG. 17 shows a 2D contour plot of the second cross-ambiguity function. Note that the cross-ambiguity function is never actually computed. In this example, establishing the presence of targets in step 71 is accomplished by computing a slice of the cross-ambiguity function along line 100, or any other line known to intersect the curve of the first cross-ambiguity function. In an alternative embodiment, in which step 71 is accomplished by computing a projection, a projection is preferably computed along the path of integration, line 102, substantially parallel to the ridges of the second cross-ambiguity function.

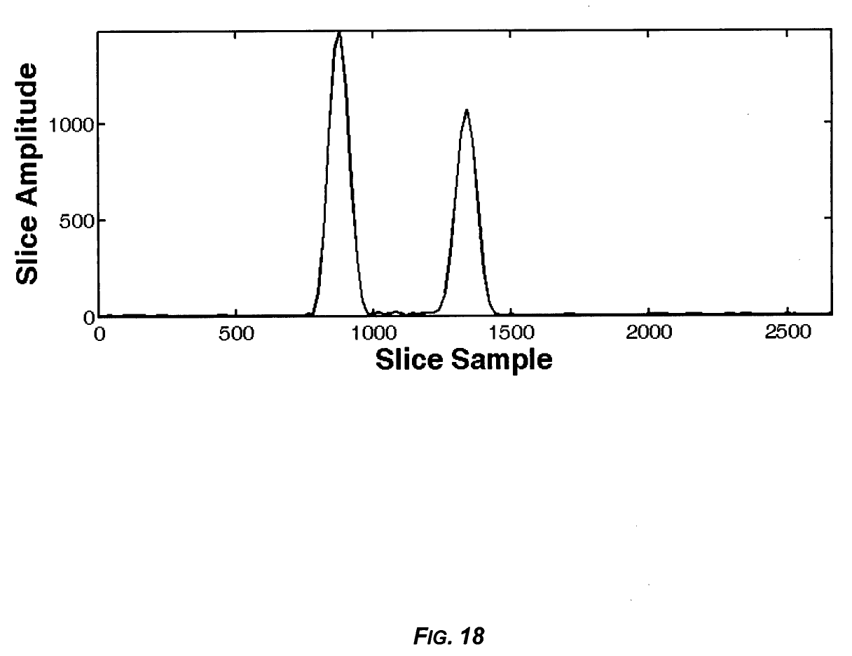

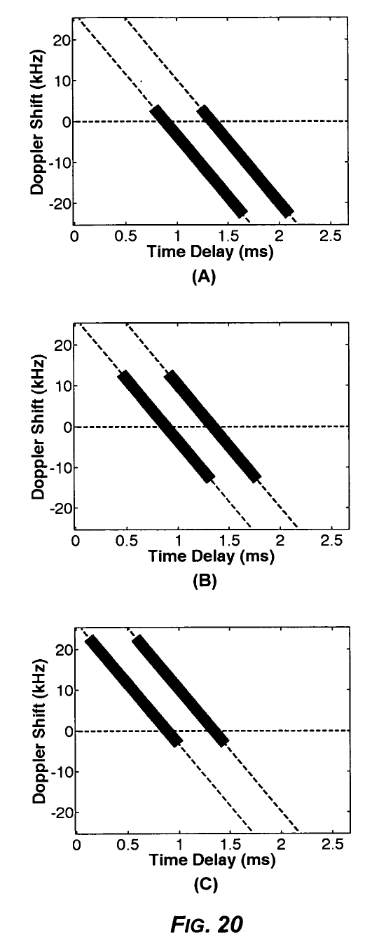

In this example, slice processor 42 computes a slice along line 100. The resulting slice is shown in FIG. 18. As shown in FIG. 18, the slice has two peaks corresponding to the two ridges shown in FIGS. 16 and 17. Because signal s₂(t) was specifically selected to be a linear frequency modulation (LFM) waveform with decreasing frequency chirp with specific parameters, its curve in the auto-ambiguity function Doppler-shift/time delay plane is known. However, the locations of one or more curves in the cross-ambiguity function Doppler-shift/time delay plane are unknown. Based on the information provided by the slice, coordinates of one or more points on the cross-ambiguity function Doppler-shift/time delay plane, it is possible that the curves are found in many possible locations in the cross-ambiguity function Doppler-shift/time delay plane while the slice has peaks in the same locations, as shown in FIGS. 20A-20C. As shown in FIGS. 20A-20C, although the locations of the curves of the first cross-ambiguity function may vary, equation of the lines on which the curves lie would be the same regardless of the actual location of the curves in the Doppler-shift/time delay plane.

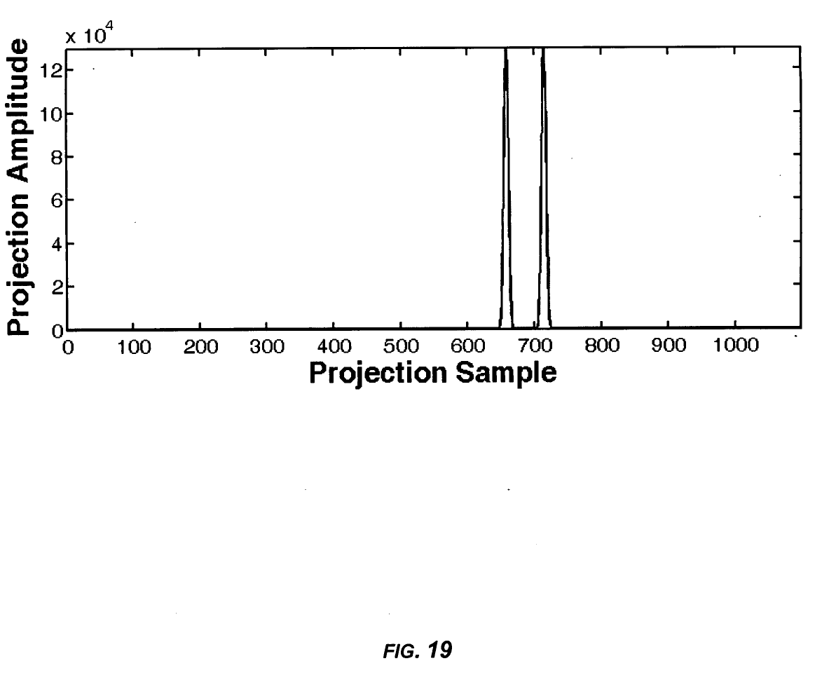

In an alternative embodiment, projection processor 44 computes a projection along path of integration 102. The resulting projection is shown in FIG. 19. As shown in FIG. 19, the projection has two peaks corresponding to the two ridges shown in FIGS. 16 and 17. Steps and computations outlined in connection with FIG. 8 may be performed to determine equations of lines over which the curves of the cross-ambiguity function lie in the Doppler-shift/time delay plane.

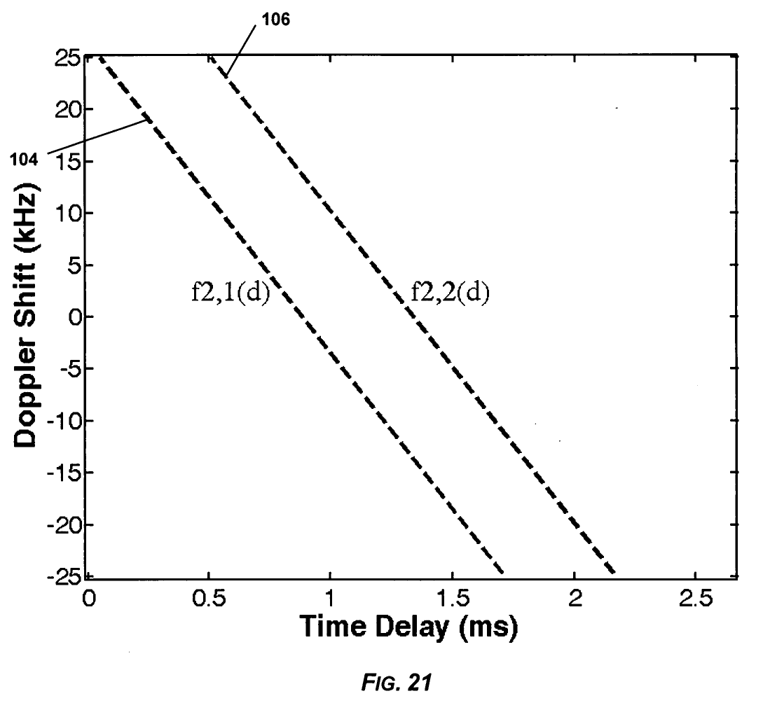

In step 72, similarly to step 66, curve processor 54 computes equations f_{2.1}(d) and f_{2.2}(d) of two lines 104, 106 shown in FIG. 21 in the cross-ambiguity function Doppler-shift/time delay plane over which the curves of the second cross-ambiguity function lie.

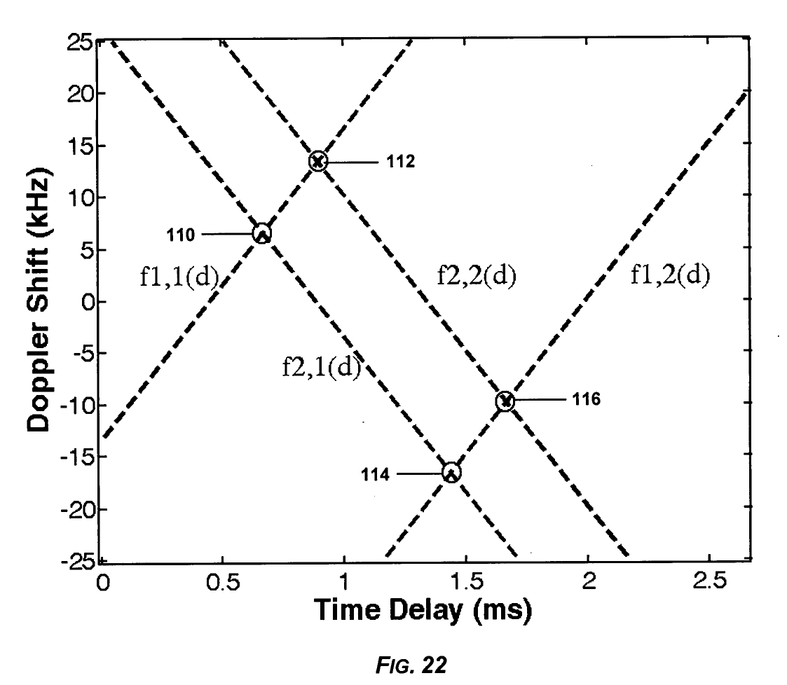

In step 74, hypothesis generator 48 generates one or more target hypotheses, which are Doppler shift/time delay coordinates of intersections of the four lines, f_{1.1}(d), f_{1.2}(d), f_{2.1}(d), and f_{2.2}(d). FIG. 22 shows the locations of these coordinates identified by numerals 110, 112, 114, 116 in the Doppler-shift/time delay plane.

FIG. 23 shows alternative steps performed for accomplishing step 2 in FIG. 2, namely generating target hypotheses of targets in the Doppler-shift/time delay plane using composite signals. Specifically, in step 160, waveform generator 14 generates samples corresponding to a desired waveform and transmitter 16 transmits signal s₁(t) based on the generated samples. In this embodiment, s₁(t) is preferably a composite signal shown in FIG. 7A that has the auto-ambiguity function shown in FIGS. 7B and 7C. In step 162, receiver 18 receives signal r₁(t) and preprocesses it.

In step 164, detection processor 20 establishes the presence of one or more positive slope ridges of the cross-ambiguity function of s₁(t) and r₁(t), the first cross-ambiguity function. Establishing the presence of one or more positive slope ridges in step 164 may be accomplished by computing a slice of the first cross-ambiguity function, with slice processor 42 or computing a projection of the cross-ambiguity function with projection processor 44, as discussed above. Finding a peak in either the computed slice or projection signifies the presence of one or more ridges, and consequently, one or more targets on each ridge.

Preferably, in step 164, slice processor 42 computes a slice parallel to the negative slope curve of the first cross-ambiguity function. This slice only crosses the positive slope line segments of the first ambiguity function. Peak detector 46 detects peaks on the slice attributable to the positive slope ridges. These peaks on the slice correspond to points in the cross-ambiguity function Doppler-shift/time delay plane. The slope of the positive slope curves is known in advance by analyzing auto-ambiguity function of s₁(t). A situation may occur when a slice that is parallel to the negative slope curve of the cross-ambiguity function Doppler-shift/time delay plane coincides with the negative slope curve. In this situation, the slice is characterized by many samples that exceed the detection threshold. If peak detector 46 encounters a slice that has a predetermined number of samples that exceed a predetermined threshold, the slice has to be recomputed, but it has to be shifted by a few samples in the cross-ambiguity function Doppler-shift/time delay plane, while still being parallel to the negative slope curve of the cross-ambiguity function.

Similarly, in embodiments that use projection processor 44 to establish the presence of one or more positive slope ridges of the first cross-ambiguity function, a projection is computed along the path of integration, oriented at an angle in the cross-ambiguity function Doppler-shift/time delay plane known to produce projection peaks in the presence of targets for the selected transmitted signal s₁(t) based on the curve of its auto-ambiguity function. Subsequently peak detector 46 analyzes the computed projection, which reveals one or more peaks corresponding to the ridges of the first cross-ambiguity function. Detecting one or more peaks corresponding to positive slope ridges of the first cross-ambiguity function signifies the presence of one or more targets.

In step 166, for each positive slope ridge of the first cross-ambiguity function, curve processor 54 computes the equation of the line in the Doppler-shift/time delay plane over which the positive slope curve of the first cross-ambiguity function lies. In embodiments that use a slice to establish the presence of ridges, a peak on the slice identifies a point in the Doppler-shift/time delay plane; the slope of the line is the same as the slope of the positive slope curve, which is known in advance from the selection of s₁(t). In embodiments that use a projection to establish the presence of ridges, a peak on the axis of the projection corresponds to the specific line that is parallel to, and intersects the curve in the Doppler shift/time delay plane. In both embodiments, the information provided by the slice or projection is sufficient to identify a point on the cross-ambiguity function Doppler-shift/time delay plane, as disclosed above.

In particular, in step 166, curve processor 54 computes line equations f₁(d) . . . fₙ(d) over which positive slope curves of the first cross-ambiguity function lie based on the slope of the positive slope curve of the first cross-ambiguity function and a point on the line in cross-ambiguity function Doppler-shift/time delay plane.

In step 167, detection processor 20 establishes the presence of one or more negative slope ridges of the first cross-ambiguity function. Establishing the presence of one or more negative slope ridges in step 167 may be accomplished by computing a slice of the first cross-ambiguity function, with slice processor 42 or computing a projection of the cross-ambiguity function with projection processor 44, as discussed above. Finding a peak in either the computed slice or projection signifies the presence of one or more negative slope ridges, and consequently one or more targets on each ridge.

Preferably, in step 167, slice processor 42 computes a slice parallel to the positive slope curve of the first cross-ambiguity function. This slice only crosses the negative slope curves of the first cross-ambiguity function. Peak detector 46 detects peaks on the slice attributable to the negative slope ridges. These peaks on the slice correspond to points in the cross-ambiguity function Doppler-shift/time delay plane. The slope of the negative slope curves is known in advance by analyzing auto-ambiguity function of s₁(t). A situation may occur when a slice that is parallel to the positive slope curve of the cross-ambiguity function Doppler-shift/time delay plane coincides with the positive slope curve. In this situation, the slice is characterized by many samples that exceed the detection threshold. If peak detector 46 encounters a slice that has a predetermined number of samples that exceed a predetermined threshold, the slice has to be recomputed, but it has to be shifted by a few samples in the cross-ambiguity function Doppler-shift/time delay plane while still being parallel to the negative slope curve of the cross-ambiguity function.

Similarly, in embodiments that use projection processor 44 to establish the presence of one or more ridges of the first cross-ambiguity function, a projection is computed along the path of integration, oriented at an angle in the cross-ambiguity function Doppler-shift/time delay plane known to produce projection peaks in the presence of targets for the selected transmitted signal s₁(t) based on the curve of its auto-ambiguity function. Subsequently, peak detector 46 analyzes the computed projection, which reveals one or more peaks corresponding to the negative slope ridges of the first cross-ambiguity function. Detecting one or more peaks corresponding to ridges of the first cross-ambiguity function signifies the presence of one or more targets.

In step 168, for each ridge of the first cross-ambiguity function, curve processor 54 computes the equation of the line in the Doppler-shift/time delay plane over which the negative slope curve of the first cross-ambiguity function lies. In embodiments that use a slice to establish the presence of ridges, a peak on the slice identifies a point in the Doppler-shift/time delay plane; the slope of the line is the same as the slope of the negative slope curve, which is known in advance from the selection of s₁(t). In embodiments that use a projection to establish the presence of ridges, a peak on the axis of the projection corresponds to the specific line that is parallel to, and intersects the curve in the Doppler shift/time delay plane.

In particular, in step 168, curve processor 54 computes line equations g₁(d) . . . gₙ(d) over which negative curves of the first cross-ambiguity function lie based on the slope of the negative slope curve of the first cross-ambiguity function and a point on the line in cross-ambiguity function Doppler-shift/time delay plane.

In step 170, hypothesis generator 48 determines intersection coordinates of lines f₁(d) . . . fₙ(d) and g₁(d) . . . gₙ(d). These Doppler shift/time delay plane coordinates are target hypotheses.

In alternative embodiments, in other embodiments projections may be used in step 164 and slices in step 167 and vise versa. Also, in some embodiments only a single slice is computed at an angle that is known to intercept both positive slope and negative slope curves of the cross-ambiguity function. In this embodiment, however, each peak on the slice has to be treated as both a possible point on both positive slope and negative slope curves. A similar embodiment using projections is also contemplated. The trade-off for computing only a single slice (or projection) is the exponential growth of the number of hypotheses with the number of target because each point found with the single slice (or projection) must be assumed as belonging to both positive slope and negative slope curves.

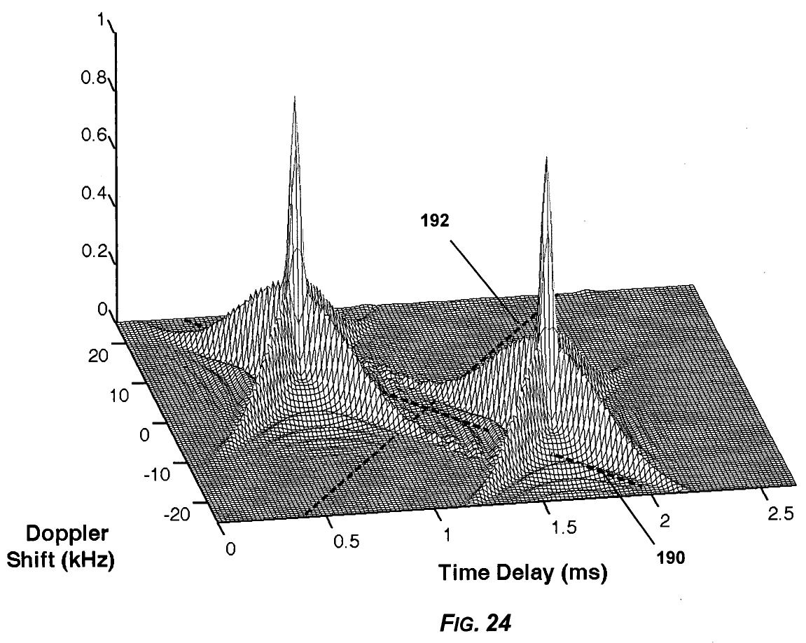

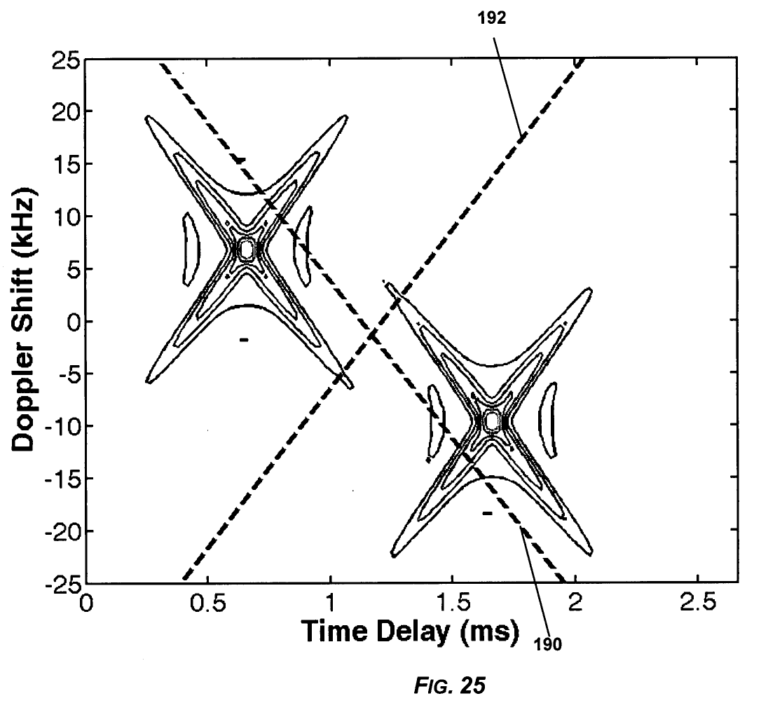

The above method of generating hypotheses using composite signals is illustrated with an example of two targets shown in FIGS. 9A and 9B. Turning to FIG. 23, in step 160, waveform generator 14 generates samples corresponding to a desired waveform s₁(t). In this example, the desired waveform is a composite of two linear frequency modulation (LFM) waveforms with both increasing and decreasing frequency chirps, which has a cross-shaped auto-ambiguity function, such as shown in FIGS. 7A-7C. Transmitter 16 processes and transmits signal s₁(t) based on the generated samples. The rate of frequency increase and the rate of frequency decrease in signal s₁(t) determine the slopes of the curves in the auto-ambiguity function Doppler-shift/time delay plane. Auto-ambiguity function of s₁(t) is preferably computed in advance and is available to curve processor 54. In step 162, receiver 18 receives signal r₁(t) and preprocesses it. In step 164, detection processor 20 establishes the presence of one or more targets. In this example, this is done using a slice. Slice processor 42 computes the slice parallel to the negative slope curve of the cross-ambiguity function of s₁(t) and r₁(t), the first cross-ambiguity function. FIG. 24 shows a 3D profile of the first cross-ambiguity function that results in the presence of the two targets shown in FIG. 9A if it were computed. FIG. 25 shows a contour plot of the first cross-ambiguity function. Note that the cross-ambiguity function is never actually computed.

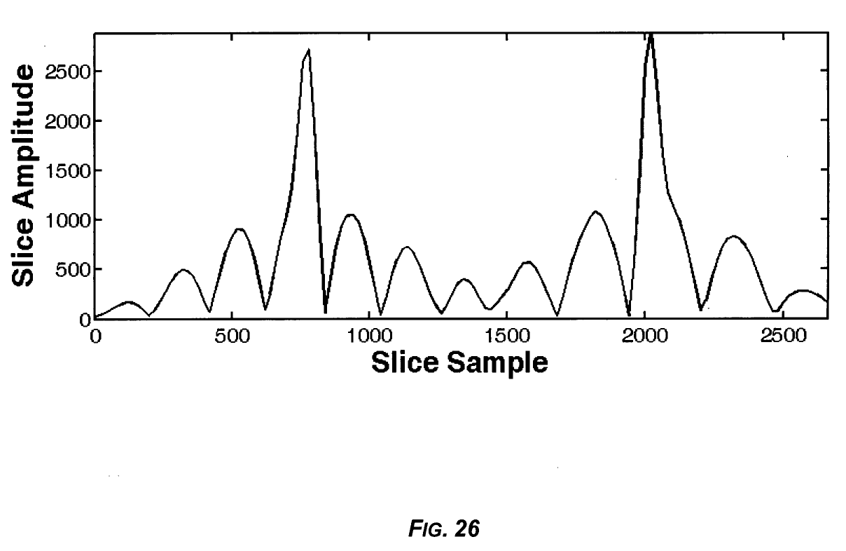

In this example, establishing the presence of positive slope ridges in step 164 is accomplished by computing a slice of the first cross-ambiguity function along line 190 shown in FIGS. 24 and 25. In an alternative embodiment, in which step 164 is accomplished by computing a projection, projection processor 44 computes a projection with the path of integration perpendicular to line 190. In this example, slice processor 42 computes a slice shown in FIG. 26 along line 190. As shown in FIG. 26, the slice has two peaks corresponding to the two positive slope curves shown in FIG. 25. Because signal s₁(t) was specifically selected to be a composite of two linear frequency modulation (LFM) waveforms with both increasing and decreasing frequency chirps with specific parameters, its curves, shown in FIG. 7C, in the Doppler-shift/time delay plane is known. However, the locations of one or more curves are unknown. Based on the information provided by the slice, it is possible that the positive slope curves are found in many possible locations in the Doppler-shift/time delay plane, as discussed above.

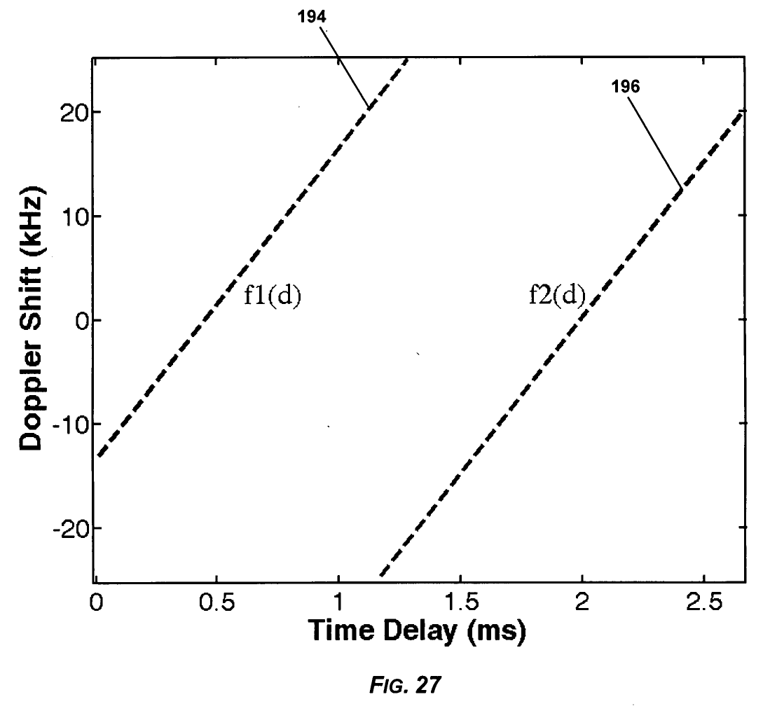

Regardless of whether a slice or projection is used to establish the presence of positive slope ridges, the information gathered in step 164 may be used in step 166 to find equations of lines over which the positive slope curves of the first cross-ambiguity function lie. The slope of these positive slope curves of the first cross-ambiguity function is known from the curves of the auto-ambiguity function of s₁(t). Based on this information, in step 166, curve processor 54 computes equations f₁(d) and f₂(d) of two lines 194, 196 shown in FIG. 27 in the cross-ambiguity function Doppler-shift/time delay plane, corresponding to the positive slope line segments of the curves of the first cross-ambiguity function.

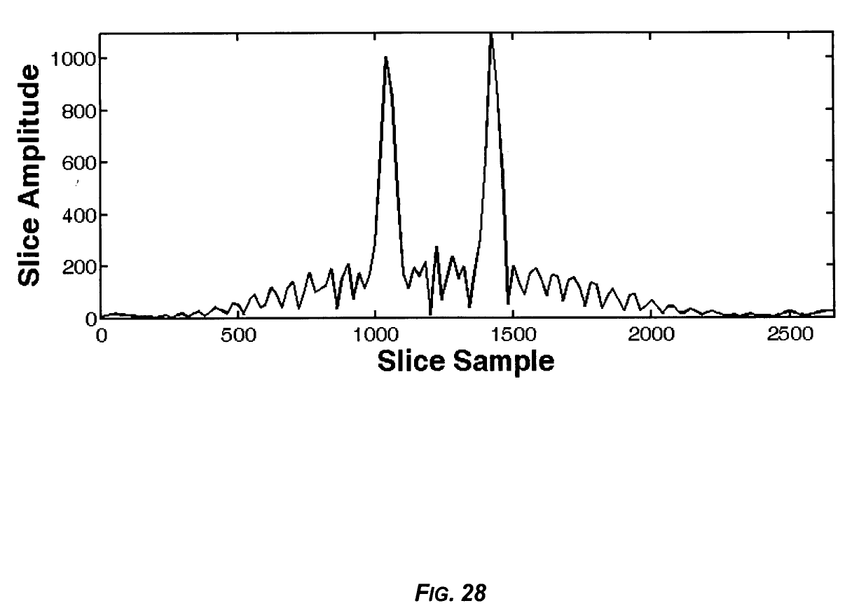

In step 167, similarly to step 164 discussed above, the presence of negative slope ridges of the first cross-ambiguity function is determined by computing a slice or projection. FIGS. 24 and 25 show line 192, the line along which a slice shown in FIG. 28 is computed in the preferred embodiment. In an alternative embodiment that uses projections in this step, the path of integration is perpendicular to line 192. As disclosed above in connection with step 164, in either embodiment, the information gathered is sufficient to find equations of lines over which negative slope curves of the first cross-ambiguity function lie.

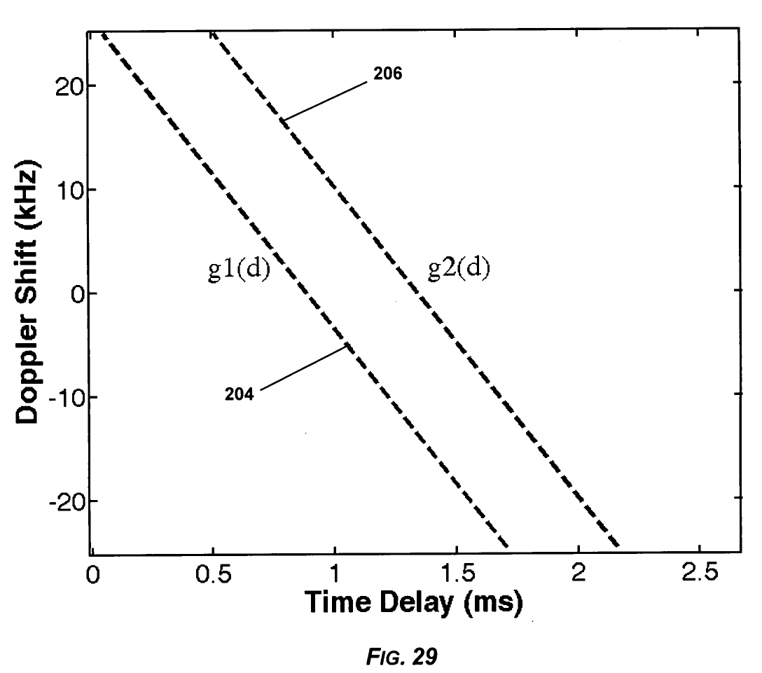

In step 168, curve processor 54 computes equations of lines over which negative slope curves of the first cross-ambiguity function lie. In particular, in this example, curve processor 54 computes equations g₁(d) and g₂(d) of two lines 204, 206, shown in FIG. 29, in the Doppler-shift/time delay plane over which the negative slope curves of the first cross-ambiguity function lie.

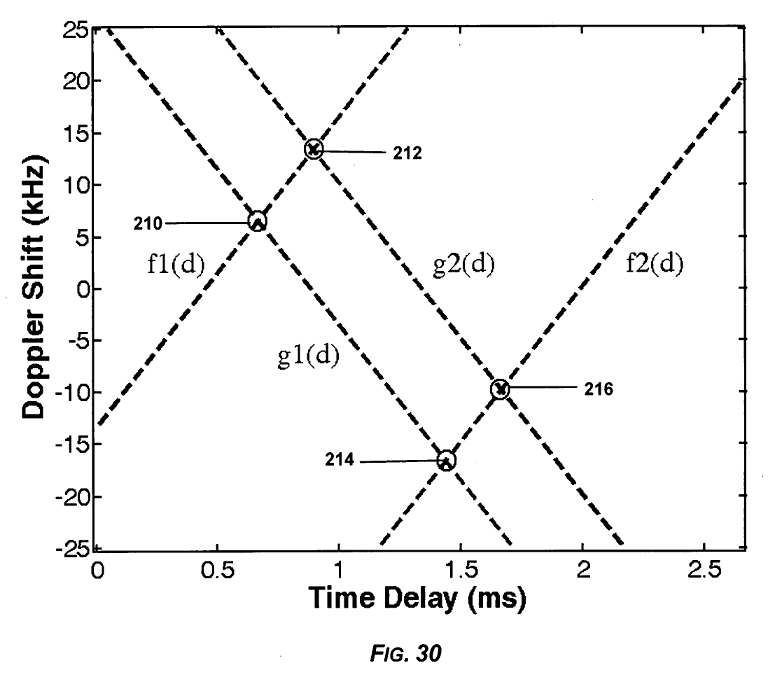

In step 170, hypothesis generator 48 generates one or more target hypotheses, which are points in the Doppler-shift/time delay plane with coordinates of intersections of the four lines, f₁(d), f₂(d), g₁(d), and g₂(d). FIG. 30 shows these coordinates identified by numerals 210, 212, 214, 216.

Note that because s₁(t) is a composite signal with auto-ambiguity function that has both positive and negative slope curves, there is no need to transmit s₂(t), and generation of hypotheses is done based on s₁(t) and r₁(t) only.

Once hypotheses are generated with steps shown in FIG. 8 using simple signals or steps shown in FIG. 23 using a composite signal or similar steps with other types of signals, the generated hypotheses are stored in the hypothesis memory 50.

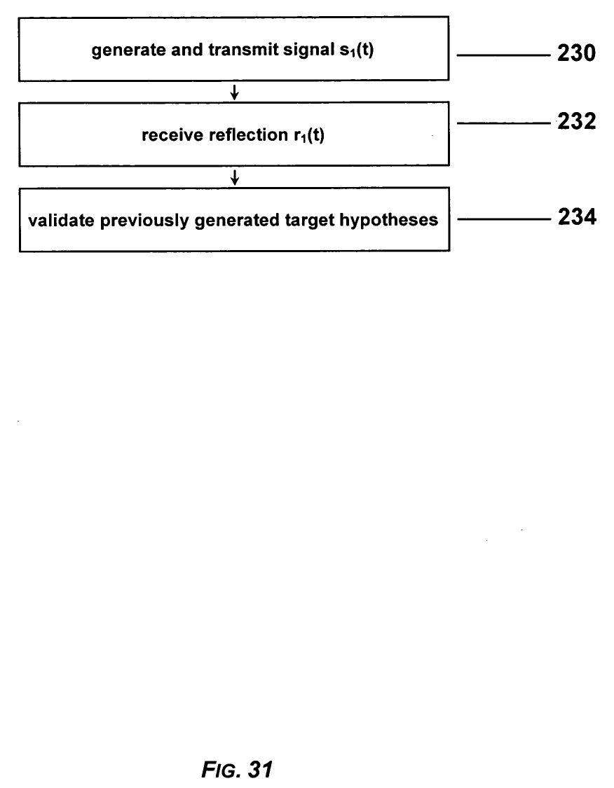

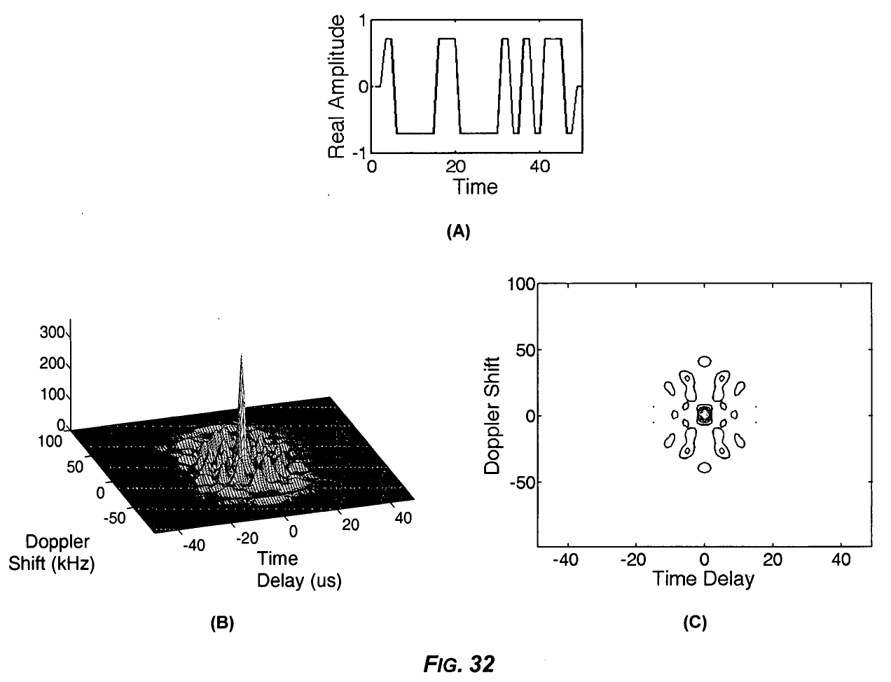

FIG. 31 shows steps performed for accomplishing step 4 in FIG. 2, identifying actual targets by validating individual hypotheses, in greater detail. In step 230, waveform generator 14 generates samples corresponding to a desired waveform and transmitter 16 transmits signal s₃(t) based on the generated samples. Signal s₃(t) is preferably selected so that it has a thumb tack auto-ambiguity function. That means that the cross-ambiguity function of s₃(t) and its reflection from a target would have a highly localized peak. An example of such signal is a pseudo-random noise signal shown in FIG. 32A. The 3D profile of the auto-ambiguity function of the pseudo-random noise signal is shown in FIG. 32B, and the 2D contour plot of the auto-ambiguity function is shown in FIG. 32C. In step 232, receiver 18 receives signal r₃(t) and preprocesses it. In step 234, hypothesis validation processor 52 validates hypotheses generated by hypothesis generator 48 and stored in hypothesis memory 50 in step 2.

Preferably, only coordinates of the generated target hypotheses have to be analyzed, because they represent the most likely locations where one or more targets may be located in the cross-ambiguity function Doppler-shift/time delay plane. The generated hypotheses correspond to coordinates through which at least two ridges of one or more cross-ambiguity function pass. Preferably, CAF processor 56 computes the amplitude of the cross-ambiguity function of s₃(t) and r₃(t), the validation cross-ambiguity function, at the coordinates of the hypotheses in the Doppler-shift/time delay plane generated by hypothesis generator 48 in step 2. Then, peak detector 46 determines whether the given amplitude is a peak. Based on this determination, hypothesis validation processor 52 identifies a target. Generally, if there is a peak at the coordinate of a hypothesis, then hypothesis validation processor 52 determines that there is a target at that coordinate in the Doppler-shift/time delay plane. In the preferred embodiment, CAF processor 56 computes a single point of the validation cross-ambiguity function for each generated hypothesis. In other embodiments CAF processor 56 may compute several points in close proximity of each hypothesis to accommodate for changes in radial velocity and distance of the target to sensor system 10. In other embodiments, slice processor 42 may compute one or more short slices passing through the tested hypothesis with given coordinate.

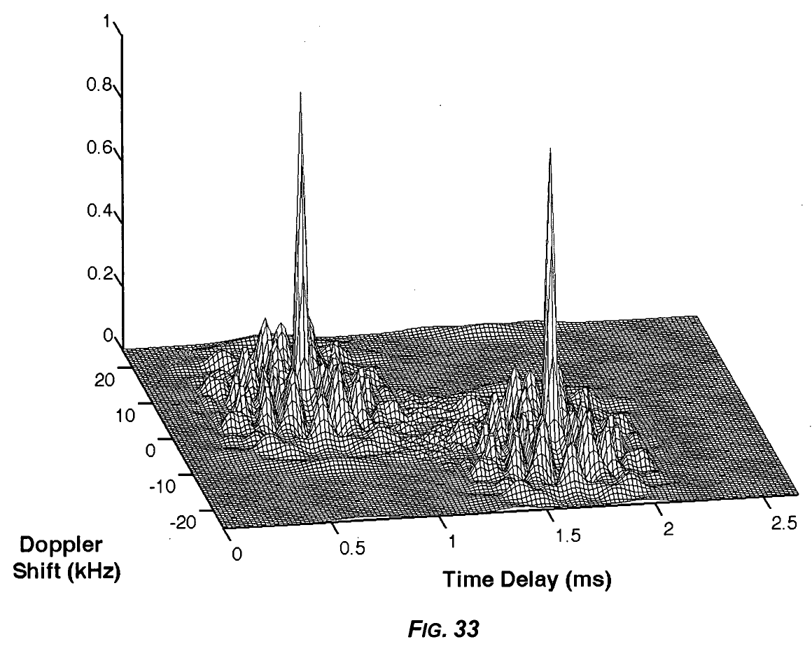

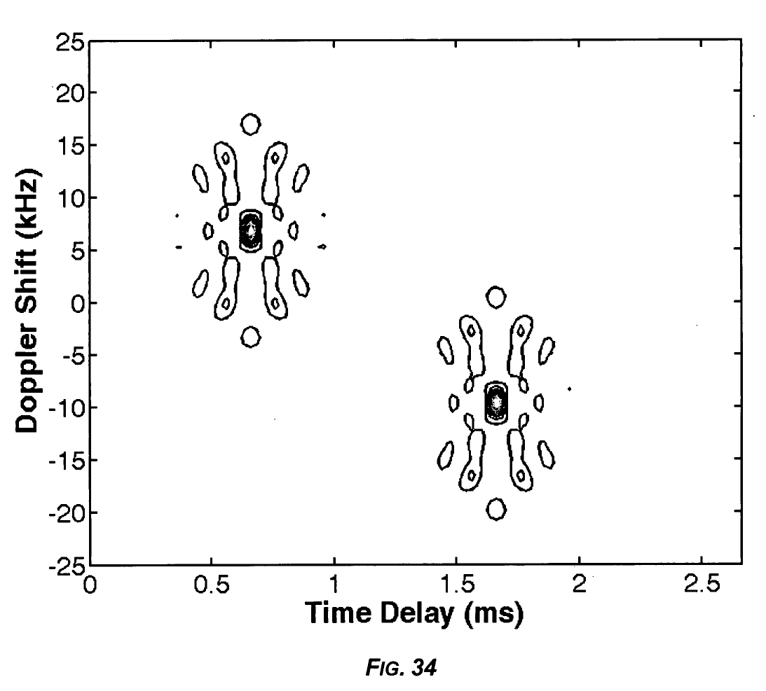

Continuing with the example of detecting targets shown in FIG. 9A, after step 2, four target hypotheses 110, 112, 114, and 116 shown in FIG. 22 (or 210, 212, 214, and 216 shown in FIG. 30, which are the same) have been stored in hypothesis memory 50. In step 230, waveform generator 14 generates samples corresponding to a desired waveform s₃(t). In this example, the desired waveform is a pseudo-random noise signal which has a thumb tack auto-ambiguity function shown in FIG. 32B. Transmitter 16 processes and transmits signal s₃(t) based on the generated samples. In step 232, receiver 18 receives signal r₃(t) and preprocesses it. In step 234, detection processor 20 detects targets by validating hypotheses stored in hypothesis memory 50. In this example, CAF processor 56 computes amplitude of the validation cross-ambiguity function, corresponding to the coordinate of each hypothesis. In other embodiments, CAF processor 56 may compute amplitude of the cross-ambiguity function at coordinates in the close proximity of the generated hypotheses to account for possible changes in distance and radial velocity. In yet some other embodiments, slice processor 42 may compute one or more slices passing through the coordinates of the generated hypotheses. FIG. 33 shows a 3D profile of the validation cross-ambiguity function that results in the presence of the two targets shown in FIG. 9A if it were computed. FIG. 34 shows a contour plot of the validation cross-ambiguity function. Note that the cross-ambiguity function is never actually computed.

In the preferred embodiment, CAF processor 56 computes the amplitude of the validation cross-ambiguity function at the coordinates of the four hypotheses. Peak detector 46 determines if the amplitudes are peaks. Hypothesis validation processor 52 analyzes the peak data and outputs the coordinates of the target. In this example, hypotheses 110 and 116 shown in FIG. 22 (210 and 216 in FIG. 30) would have amplitude that exceeds a predetermined detection threshold and would be identified as peaks by peak detector 46 and as targets by hypothesis validation processor 52. The other two hypotheses have amplitudes that do not exceed the detection threshold and would not be identified as targets.

The foregoing description of the preferred embodiments of the present invention has been presented for purposes of illustration and description. In alternative embodiments, the order of steps may vary from those disclosed in FIGS. 8, 23, and 31. In embodiments using simple signals, sensor system 10 may transmit the first two signals and only then perform computations associated with hypothesis generation. Furthermore, sensor system 10 may transmit all signals, and receive all reflections before performing any computations of projection or slices. It is also contemplated that transmission of signals and receiving of reflections may be performed at one time, and subsequent computations may be performed at a later time. Such an embodiment may be useful for reconnaissance missions.

Also, the exemplary embodiments herein disclosed do not limit the multistep detection method to three phases. The present disclosure contemplates a method of multiple phases to form target hypotheses and perform hypothesis validation. More than two unique linear ridge auto-ambiguity function waveforms may be employed for the phases of hypothesis generation and more than one thumb tack auto-ambiguity function waveform may be used for the phases of hypothesis validation.

In further embodiments, this invention also includes computer readable media (such as hard drives, non-volatile memories, CD-ROMs, DVDs, network file systems) with instructions for causing a processor or a computer system to perform the methods of this invention, special purpose integrated circuits designed to perform the methods of this invention, and the like.

The invention described and claimed herein is not to be limited in scope by the exemplary embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed:

1. A method of detecting one or more targets comprising:
a. generating one or more target hypotheses in a Doppler-shift/time delay plane based on one or more curves of one or more cross ambiguity functions of one or more transmitted signals and their received reflections from the one or more targets; and
b. determining one or more coordinates of the one or more targets in the Doppler-shift/time delay plane by validating the one or more generated target hypotheses,
wherein the Doppler-shift/time delay plane is a cross-ambiguity function Doppler-shift/time plane.

2. The method of claim 1, wherein generating the one or more target hypotheses in the Doppler-shift/time delay plane comprises determining coordinates of intersections of curves of the one or more cross-ambiguity functions in the Doppler-shift/time delay plane.

3. The method of claim 2, wherein generating one or more target hypotheses in the Doppler-shift/time delay plane further comprises:
a. transmitting a first signal;
b. receiving a reflection of the first signal from the one or more targets; and
c. computing one or more first equations of one or more lines in the Doppler-shift/time delay plane over which first curves of the cross-ambiguity function of the first signal and the received reflection of the first signal lie.

4. The method of claim 3, wherein generating one or more target hypotheses in the Doppler-shift/time delay plane further comprises:
a. computing one or more second equations of one or more lines in the Doppler-shift/time delay plane over which second curves of the cross-ambiguity function of the first signal and the received reflection of the first signal lie; and
b. generating the one or more target hypotheses by determining coordinates of the one or more intersection of the one or more first lines and the one or more second lines in the Doppler-shift/time delay plane.

5. The method of claim 4, wherein computing the one or more first equations comprises computing one or more of: (a) a slice of the cross-ambiguity function of the first signal and the received reflection of the first signal, and (b) a projection of the cross-ambiguity function of the first signal and the received reflection of the first signal; and computing the one or more second equations comprises computing one or more of: (a) a slice of the cross-ambiguity function of the first signal and the received reflection of the first signal, and (b) a projection of the cross-ambiguity function of the first signal and the received reflection of the first signal.

6. The method of claim 3 wherein generating one or more target hypotheses in the Doppler-shift/time delay plane further comprises:
a. transmitting a second signal;
b. receiving a reflection of the second signal from the one or more targets;
c. computing one or more second equations of one or more lines in the Doppler-shift/time delay plane over which one or more curves of the cross-ambiguity function of the second signal and the received reflection of the second signal lie; and
d. generating the one or more target hypotheses by determining coordinates of the one or more intersection of the one or more first lines and the one or more second lines in the Doppler-shift/time delay plane.

7. The method of claim 6, wherein computing the one or more first equations comprises computing one or more of: (a) a slice of the cross-ambiguity function of the first signal and the received reflection of the first signal, and (b) a projection of the cross-ambiguity function of the first signal and the received reflection of the first signal; and computing the one or more second equations comprises computing one or more of: (a) a slice of the cross-ambiguity function of the second signal and the received reflection of the second signal, and (b) a projection of the cross-ambiguity function of the second signal and the received reflection of the second signal.

8. The method of claim 3 wherein the first signal is a composite of two linear frequency modulated (LFM) waveforms wherein one LFM waveform has an increasing frequency chirp and the other LFM waveform has a decreasing frequency chirp.

9. The method of claim 6 wherein the first signal is one of: (a) a linear frequency modulated signal with an increasing frequency chirp; and (b) a linear frequency modulated signal with a decreasing frequency chirp.

10. The method of claim 9 wherein the second signal is one of: (a) a linear frequency modulated signal with an increasing frequency chirp; and (b) a linear frequency modulated signal with a decreasing frequency chirp.

11. The method of claim 2, wherein determining the one or more coordinates of the one or more targets comprises:
a. transmitting a validation signal;
b. receiving a reflection of the validation signal from the one or more targets;
c. computing the amplitude of the cross-ambiguity function of the validation signal and the received reflection of the validation signal at the coordinates of the one or more generated hypotheses in the Doppler-shift/time delay plane; and
d. analyzing the computed amplitude,
wherein the validation signal may comprise a pseudo-random noise signal.

12. The method of claim 11 further comprising the step of computing the amplitude of the cross-ambiguity function of the validation signal and the received reflection of the validation signal at coordinates in close proximity of the coordinates of the one or more generated hypotheses in the Doppler-shift/time delay plane.

13. A system for detecting one or more targets comprising:
a. a waveform generator;
b. a signal transmitter;
c. a signal receiver; and
d. a detection processor comprising:
i. a curve processor;
ii. a target hypothesis generator configured to generate cross-ambiguity function Doppler-shift/time delay coordinates of one or more target hypotheses based on curves of one or more cross-ambiguity functions; and
iii. a hypothesis validation processor.

14. The system of claim 13, wherein the detection processor further comprises one or more of: (a) a projection processor; (b) a slice processor; and (c) a cross-ambiguity function processor.

15. The system of claim 12, wherein the detection processor further comprises a peak detector.

16. A system for detecting one or more targets comprising:
a. means for generating one or more target hypotheses in a Doppler-shift/time delay plane based on one or more curves of one or more cross ambiguity functions of one or more transmitted signals and their received reflections from the one or more targets; and
b. means for determining one or more coordinates of the one or more targets in the Doppler-shift/time delay plane by validating the one or more generated target hypotheses,
wherein the Doppler-shift/time delay plane is a cross-ambiguity function Doppler-shift/time plane.

17. The system of claim 16, wherein means for generating the one or more target hypotheses in the Doppler-shift/time delay plane comprises means for determining coordinates of intersections of curves of the one or more cross-ambiguity functions in the Doppler-shift/time delay plane.

18. The system of claim 17, wherein the means for determining the one or more coordinates of the one or more targets comprises:
a. means for computing the amplitude of the cross-ambiguity function of a validation signal and a received reflection of the validation signal at the coordinates of the one or more generated hypotheses in the Doppler-shift/time delay plane; and
b. means for analyzing the computed amplitude.

19. A computer program product comprising a medium with instructions stored thereon that cause a computer system to:
a. generate one or more target hypotheses in a Doppler-shift/time delay plane based on one or more curves of one or more cross ambiguity functions of one or more transmitted signals and their received reflections from the one or more targets; and
b. determine one or more coordinates of the one or more targets in the Doppler-shift/time delay plane by validating the one or more generated target hypotheses,
wherein the Doppler-shift/time delay plane is a cross-ambiguity function Doppler-shift/time plane.

20. The computer program product of claim 19, wherein the instructions causing the computer system to generate the one or more target hypotheses in the Doppler-shift/time delay plane comprise instructions that cause the computer system to determine coordinates of intersections of curves of the one or more cross-ambiguity functions in the Doppler-shift/time delay plane.

21. The computer program product of claim 20, wherein the instructions causing the computer system to determine the one or more coordinates of the one or more targets comprise instructions that cause the computer system to:
a. compute the amplitude of the cross-ambiguity function of a validation signal and a received reflection of the validation signal at the coordinates of the one or more generated hypotheses in the Doppler-shift/time delay plane; and
b. analyze the computed amplitude.
